(19) United States
(12) Patent Application Publication
(10) Pub. No.: US 2025/0057187 A1
(43) Pub. Date: Feb. 20, 2025

(54) A SYSTEM AND METHOD OF CREATING A FIBRE

(71) Applicant: Audra Labs Pte. Ltd., Singapore (SG)

(72) Inventor: Mohammed Shahrudin Bin IBRAHIM, Singapore (SG)

(21) Appl. No.: 18/724,483

(22) PCT Filed: Dec. 27, 2022
(86) PCT No.: PCT/SG2022/050935

§ 371 Date: Jun. 26, 2024

(30) Foreign Application Priority Data
Dec. 28, 2021 (SG) 10202114429R

(51) Int. Cl. A23J 3/28; A23J 3/14; A23J 3/22; A23L 29/256; A23L 29/275; D01D 4/02; D01D 5/04; D01D 5/28; D01D 7/00

(52) U.S. Cl. CPC A23J 3/28; A23J 3/14; A23J 3/227; A23L 29/256; A23L 29/275; D01D 4/02; D01D 5/04; D01D 5/28; D01D 7/00; D10B 2211/20; D10B 2331/00

(57) ABSTRACT

There is provided a system for creating a fibre, the system comprising, a first tube having a first tube outlet for dispensing a first liquid composition at a first dispensing rate; a second tube having a second tube outlet for dispensing a second liquid composition at a second dispensing rate; and a rotatable collector for applying a drawing force to draw and collect the fibre, said rotatable collector being configured to rotate about its longitudinal axis that is aligned substantially parallel to a horizontal plane; wherein the first tube is positioned in proximity with respect to the second tube to allow the first liquid composition from the first tube outlet and the second liquid composition from the second tube outlet to form an interfacial polyelectrolyte complex where a fibre is to be drawn therefrom.

### TECHNICAL FIELD

The present disclosure relates broadly to a system and method of creating a fibre.

### BACKGROUND

The process of fibre formation by interfacial polyelectrolyte complexation (IPC) has been investigated for many applications. IPC is an ambient temperature process that can employ near neutral pH aqueous solutions, thus allowing viable encapsulation of various materials. The inherent characteristics of IPC-drawn fibres, such as being comprised of finer nuclear fibres, allow it to approximate the microstructure of muscle and make it suitable for fabrication of meat substitutes/analogues via encapsulation of proteins and other food components.

However, while IPC has been shown to be suitable for various applications, previous IPC processes have not been scalable and are relatively slow. Furthermore, previous methods have not been able to produce fine fibers in a continuous manner. As such, previous IPC processes have only been done on the laboratory scale. In addition, IPC was previously only applied to polycation-polyanion solution pairs. Typically, the drawing process is performed by using either a pair of forceps, or the tip of a syringe needle that has been made adhesive. After drawing the fibre to a desired length, fibre constructs are made by spooling the fibres using a pitchfork-like apparatus or wound around polymer film supports. These processes are not easily amenable to a scaled-up process, such as those used in commercial product manufacture.

As for production of meat substitutes, current techniques typically involve conveying a suspension of protein-rich plant material through an extruder at high temperature and pressure. Extrusion at high temperature has been required for the protein to form fibre-like structures imitating muscle fibres in meat. However, the use of high temperature and pressure makes it difficult to incorporate ingredients that are sensitive to temperature and pressure, e.g., bioactive ingredients, and to maintain the nutritional value of these ingredients.

Thus, there is a need for a system and method of creating a fibre, which seek to address or at least ameliorate one of the above problems.

### SUMMARY

In one aspect, there is provided a system for creating a fibre, the system comprising, a first tube having a first tube outlet for dispensing a first liquid composition at a first dispensing rate; a second tube having a second tube outlet for dispensing a second liquid composition at a second dispensing rate; and a rotatable collector for applying a drawing force to draw and collect the fibre, said rotatable collector being configured to rotate about its longitudinal axis that is aligned substantially parallel to a horizontal plane; wherein the first tube is positioned in proximity with respect to the second tube to allow the first liquid composition from the first tube outlet and the second liquid composition from the second tube outlet to form an interfacial polyelectrolyte complex where a fibre is to be drawn therefrom.

In one embodiment of the system as disclosed herein, the first tube is positioned in proximity with respect to the second tube to: allow the first liquid composition dispensed from the first tube outlet to flow into the second tube outlet via capillary action to form the interfacial polyelectrolyte complex with the second liquid composition within the second tube, and where the second tube is configured to facilitate a dispensing force provided by the second dispensing rate to eject the fibre from the interfacial polyelectrolyte complex and contact a target location on a surface of the rotatable collector; and/or allow the first liquid composition dispensed from the first tube outlet and the second liquid composition dispensed from the second tube outlet to form a droplet, said droplet comprising the first and second liquid compositions separated by the interfacial polyelectrolyte complex within the droplet, and where the fibre is drawn from the interfacial polyelectrolyte complex within the droplet when the droplet travels and contacts with a target location on a surface of the rotatable collector.

In one embodiment of the system as disclosed herein, the rotatable collector is positioned relative to the first and second tubes, such that the fibre moves in a direction away from the outlets of the first and second tubes upon contacting the target location on the surface of the rotatable collector when the rotatable collector is in rotation.

In one embodiment of the system as disclosed herein, the rotatable collector is configured to facilitate a drawing force that allows the fibre to continuously increase in length, by rotating in a direction to continuously draw the fibre from the interfacial polyelectrolyte complex.

In one embodiment of the system as disclosed herein, the first and second tube outlets are positioned at a distance falling in the range of 0.5 cm to 5 cm away from the surface of the rotatable collector.

In one embodiment of the system as disclosed herein, the first and second tubes have an inner diameter falling in the range of from 0.25 mm to 4 mm.

In one embodiment of the system as disclosed herein, the rotatable collector is configured to rotate about its longitudinal axis at a rotational speed falling in the range of from 1.5 revolutions per minute (RPM) to 8 RPM.

In one embodiment of the system as disclosed herein, the first and second dispensing rate fall in the range of from 0.1 ml/min to 0.8 ml/min.

In one embodiment of the system as disclosed herein, the first tube and second tube are configured to be movable relative to the rotatable collector along an axis that is substantially parallel to the longitudinal axis of the rotatable collector.

In one embodiment of the system as disclosed herein, the system further comprises an elongate support member having a longitudinal axis arranged to be substantially parallel to the longitudinal axis of the rotatable collector, wherein the elongate support member comprises a plurality of the first tube and second tube coupled thereto, and wherein the elongate support member is configured to be movable along its longitudinal axis relative to the rotatable collector.

In one embodiment of the system as disclosed herein, the system further comprises a guide member coupled to the first and second tubes, said guide member comprising a surface with one or more grooves formed thereon for guiding a flow direction of the first and second liquid compositions, and a groove tip disposed at one end of the one or more grooves for focusing the first and second liquid compositions prior to leaving the guide member.

In one aspect, there is provided a method of creating a fibre, the method comprising, positioning a first tube in proximity with respect to a second tube; dispensing a first liquid composition from the first tube having a first tube outlet at a first dispensing rate; dispensing a second liquid composition from the second tube having a second tube outlet at a second dispensing rate; forming an interfacial polyelectrolyte complex between the first liquid composition from the first tube outlet and the second liquid composition from the second tube outlet; drawing a fibre from the interfacial polyelectrolyte complex; and applying a drawing force by rotating the rotatable collector about its longitudinal axis that is aligned substantially parallel to a horizontal plane to draw and collect the fibre.

In one embodiment of the method as disclosed herein, forming the interfacial polyelectrolyte complex and drawing the fibre from the interfacial polyelectrolyte complex comprise, allowing the first liquid composition dispensed from the first tube outlet to flow into the second tube outlet via capillary action to form the interfacial polyelectrolyte complex with the second liquid composition within the second tube, ejecting the fibre from the interfacial polyelectrolyte complex through a dispensing force provided by the second dispensing rate in the second tube, and contacting the fibre on a target location on a surface of the rotatable collector; and/or allowing the first liquid composition dispensed from the first tube outlet and the second liquid composition dispensed from the second tube outlet to form a droplet, said droplet comprising the first and second liquid compositions separated by the interfacial polyelectrolyte complex within the droplet, allowing the droplet to travel and contact a target location on a surface of the rotatable collector, and drawing the fibre from the interfacial polyelectrolyte complex within the droplet that is in contact with the target location on the surface of the rotatable collector.

In one embodiment of the method as disclosed herein, the fibre is allowed to move in a direction away from the outlets of the first and second tubes upon contacting the target location on the surface of the rotatable collector when the rotatable collector is in rotation.

In one embodiment of the method as disclosed herein, rotating the rotatable collector comprises drawing the fibre from the interfacial polyelectrolyte complex with a drawing force that allows the fibre to be continuously increasing in length.

In one embodiment of the method as disclosed herein, the first liquid composition comprises a crosslinker and the second liquid composition comprises a polyion; or the first liquid composition comprises a first polyion and the second liquid composition comprises a second polyion, where the first polyion and the second polyion are oppositely charged.

In one embodiment of the method as disclosed herein, the first liquid composition comprising the crosslinker has a concentration falling in the range of from 0.5% (w/v) to 5% (w/v) of the first liquid composition, and the second liquid composition comprising the polyion has a concentration falling in the range of from 0.5% (w/v) to 1.2% (w/v) of the second liquid composition; or the first liquid composition comprising the first polyion has a concentration falling in the range of from 0.5% (w/v) to 2.5% (w/v) of the first liquid composition, and the second liquid composition comprising the second polyion has a concentration falling in the range of from 0.5% (w/v) to 1.2% (w/v) of the second liquid composition.

In one embodiment of the method as disclosed herein, the first and/or second liquid compositions further comprise one or more of the following components: 5% (w/v) to 20% (w/v) of at least one protein isolate; 5% (w/v) to 20% (w/v) of at least one flour; 5% (v/v) to 20% (v/v) of at least one oil; and 0.5% (w/v) to 2.5% (w/v) of at least one gum.

In one embodiment of the method as disclosed herein, the second liquid composition comprising the polyion or second polyion has a viscosity of from 5,000 to 50,000 centiPoise (cPs).

In one embodiment of the method as disclosed herein, the rotatable collector is rotated about the longitudinal axis at a rotational speed falling in the range of from 1.5 RPM to 8 RPM.

In one embodiment of the method as disclosed herein, the first and second dispensing rates fall in the range of from 0.1 ml/min to 0.8 ml/min.

In one embodiment of the method as disclosed herein, the fibre has an average diameter falling in the range of from 0.05 mm to 0.50 mm.

In one embodiment of the method as disclosed herein, the method further comprises maintaining the first and second tubes in a fixed position relative to the longitudinal axis of the rotatable collector, such that newly drawn portions of the fibre are overlaid on top of previously drawn portions of the fibre collected on the rotatable collector.

In one embodiment of the method as disclosed herein, the method further comprises moving the first tube and second tube relative to the rotatable collector along an axis that is substantially parallel to the longitudinal axis of the rotatable collector, such that newly drawn portions of the fibre are laid adjacent to previously drawn portions of the fibre collected on the rotatable collector.

In one embodiment of the method as disclosed herein, the method further comprises dispensing the first and second liquid compositions from a plurality of the first tube and second tube, wherein the plurality of the first tube and second tube are coupled to an elongate support member having a longitudinal axis arranged to be substantially parallel to the longitudinal axis of the rotatable collector; and moving the elongate support member along its longitudinal axis relative to the rotatable collector.

### Definitions

The term “biocompatible” as used herein is to be interpreted broadly to refer to the ability of a material to perform its intended function without inducing significant inflammatory response, immunogenicity, or cytotoxicity to native cells, tissues, or organs.

The term “biodegradable” as used herein is to be interpreted broadly to refer to a material that is capable of being broken down physically and/or chemically within the body of a subject, e.g., by hydrolysis under physiological conditions, by natural biological processes such as the action of enzymes present within the body, etc., to form smaller chemical species which can be metabolized and/or excreted.

The term “encapsulate” as defined herein means to entrap material(s) within the boundary/confines of a fibre matrix.

The term “food grade” as used herein is to be interpreted broadly to refer to a substance that is approved for human consumption by a relevant authority in a jurisdiction, e.g., the Food and Drug Administration (FDA) in the U.S. and the Singapore Food Agency in Singapore.

The terms “horizontal” and “vertical” are used with reference to a system for creating a fibre, said system being placed in a position that is ready for its normal operations, e.g., substantially upright on a horizontal surface (e.g., a ground). For example, for a system that is placed or installed upright on a horizontal surface, a vertical axis may pass from the horizontal surface vertically upwards through the system. A horizontal axis may be normal/perpendicular to the vertical axis, i.e., a horizontal axis may be parallel to the horizontal surface and passing horizontally through the system. In various embodiments, the axes of the system are the X, Y and Z axes, and those axes are defined as follows: X-axis is the horizontal axis; Y-axis is the vertical axis; and Z-axis is orthogonal to the X-axis and Y-axis. In various embodiments, these axes are also used to define planes discussed herein. For example, X-Y and Y-Z planes are vertical planes that are normal to a horizontal surface e.g., the ground; and a X-Z plane is a horizontal plane that is parallel to a horizontal surface e.g., the ground and perpendicular to the X-Y and Y-Z planes.

The term “interfacial polyelectrolyte complexation” as used herein refers to a process whereby fibres are formed through interactions at the interface of a pair of oppositely charged polyions or a pair of polyion and crosslinker. The term “interfacial polyelectrolyte complex” as used herein refers to the polyelectrolyte complex formed at the interface of two oppositely charged polyelectrolyte solutions upon contact with each other. This interfacial polyelectrolyte complex acts as a viscous barrier which prevents free mixing of the two solutions and is a pre-requisite for IPC fibre formation. The term “interfacial polyelectrolyte complex” also refers to the interface where polyion-crosslinker pairs that are able to react/polymerise almost immediately upon contact with each other form a viscous barrier at said interface in the same way as oppositely charged polyelectrolytes. An example would be free radical polymerisation reactions.

The term “polyelectrolyte” or “polyion” as used herein refers to a polymer which under some set of conditions (e.g., physiological conditions) has a net positive or negative charge. Polycations have a net positive charge and polyanions have a net negative charge. The net charge of a given polyelectrolyte or polyion may depend on the surrounding chemical conditions, e.g., on the pH.

The term “substrate” as used herein is to be interpreted broadly to refer to any supporting structure.

The term “layer” when used to describe a first material is to be interpreted broadly to refer to a first depth of the first material that is distinguishable from a second depth of a second material. The first material of the layer may be present as a continuous film, as discontinuous structures or as a mixture of both. The layer may also be of a substantially uniform depth throughout or varying depths. Accordingly, when the layer is formed by individual structures, the dimensions of each of individual structure may be different. The first material and the second material may be same or different and the first depth and second depth may be same or different.

The term “continuous” when used to describe a fibre or fibre construct is to be interpreted broadly to refer to a fibre or fibre construct that is substantially without gaps or holes or voids across the length of the fibre or fibre construct. In this regard, a continuous fibre or fibre construct is also intended to include a fibre or fibre construct that may have trivial gaps or holes or voids that may not appreciably affect the desired properties of the fibre or fibre construct. Accordingly, it is also appreciated that the continuous fibre or fibre construct disclosed herein may be formed from very closely and densely packed structures. For instance, the continuous fibre or fibre construct may be grown from densely packed growth sites where each growth site/fibre nucleation site is in proximity or abutting its adjacent growth sites/fibre nucleation sites.

The term “micro” as used herein is to be interpreted broadly to include dimensions from about 1 micron to about 1000 microns.

The term “nano” as used herein is to be interpreted broadly to include dimensions less than about 1000 nm.

The term “particle” as used herein broadly refers to a discrete entity or a discrete body. The particle described herein can include an organic, an inorganic or a biological particle. The particle used described herein may also be a macro-particle that is formed by an aggregate of a plurality of sub-particles or a fragment of a small object. The particle of the present disclosure may be spherical, substantially spherical, or non-spherical, such as irregularly shaped particles or ellipsoidally shaped particles. The term “size” when used to refer to the particle broadly refers to the largest dimension of the particle. For example, when the particle is substantially spherical, the term “size” can refer to the diameter of the particle; or when the particle is substantially non-spherical, the term “size” can refer to the largest length of the particle.

The terms “coupled” or “connected” as used in this description are intended to cover both directly connected or connected through one or more intermediate means, unless otherwise stated.

The term “associated with”, used herein when referring to two elements refers to a broad relationship between the two elements. The relationship includes, but is not limited to a physical, a chemical or a biological relationship. For example, when element A is associated with element B, elements A and B may be directly or indirectly attached to each other or element A may contain element B or vice versa.

The term “adjacent” used herein when referring to two elements refers to one element being in close proximity to another element and may be but is not limited to the elements contacting each other or may further include the elements being separated by one or more further elements disposed therebetween.

The term “and/or”, e.g., “X and/or Y” is understood to mean either “X and Y” or “X or Y” and should be taken to provide explicit support for both meanings or for either meaning.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For example, when “comprising” is used, reference to a “one” feature is also intended to be a reference to “at least one” of that feature. Terms such as “consisting”, “consist”, and the like, may in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. It is to be appreciated that the individual numerical values within the range also include integers, fractions and decimals. Furthermore, whenever a range has been described, it is also intended that the range covers and teaches values of up to 2 additional decimal places or significant figures (where appropriate) from the shown numerical end points. For example, a description of a range of 1% to 5% is intended to have specifically disclosed the ranges 1.00% to 5.00% and also 1.0% to 5.0% and all their intermediate values (such as 1.01%, 1.02% . . . 4.98%, 4.99%, 5.00% and 1.1%, 1.2% . . . 4.8%, 4.9%, 5.0% etc.,) spanning the ranges. The intention of the above specific disclosure is applicable to any depth/breadth of a range.

Additionally, when describing some embodiments, the disclosure may have disclosed a method and/or process as a particular sequence of steps. However, unless otherwise required, it will be appreciated that the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Furthermore, it will be appreciated that while the present disclosure provides embodiments having one or more of the features/characteristics discussed herein, one or more of these features/characteristics may also be disclaimed in other alternative embodiments and the present disclosure provides support for such disclaimers and these associated alternative embodiments.

### DESCRIPTION OF EMBODIMENTS

Exemplary, non-limiting embodiments of a system and method of creating a fibre are disclosed hereinafter.

### System for Creating a Fibre

In various embodiments, there is provided a system for creating a fibre, the system comprising, a first tube having a first tube outlet for dispensing a first liquid composition (e.g., a polyion or a crosslinker solution) at a first dispensing rate; a second tube having a second tube outlet for dispensing a second liquid composition (e.g., another polyion solution) at a second dispensing rate; and a rotatable collector (e.g., rotatable cylinder) for applying a drawing force to draw and collect the fibre, said rotatable collector being configured to rotate about its longitudinal axis that is aligned substantially parallel to a horizontal plane; wherein the first tube is positioned in proximity with respect to the second tube to allow the first liquid composition from the first tube outlet and the second liquid composition from the second tube outlet to form an interfacial polyelectrolyte complex where a fibre is to be drawn therefrom.

In various embodiments, the system is configured for creating an IPC fibre. In various embodiments, the system is configured for creating a continuous length of fibre, e.g., IPC fibre. In various embodiments, the fibre does not substantially break during fibre drawing and collection. In various embodiments, the system for creating a fibre relates to a system for fibre production and assembly. In various embodiments, the system for creating a fibre may be used to create a fibre construct comprising a plurality of fibres.

In various embodiments, the system or associated method disclosed herein may be configured to create the fibre via a first mechanism, where the first tube is positioned in proximity with respect to the second tube to allow the first liquid composition dispensed from the first tube outlet to flow into the second tube outlet via capillary action to form the interfacial polyelectrolyte complex with the second liquid composition within the second tube, and where the second tube is configured to facilitate a dispensing force provided by the second dispensing rate to eject the fibre from the interfacial polyelectrolyte complex within the second tube and contact a target location on a surface of the rotatable collector.

In various embodiments, the first mechanism comprises forming an initial droplet in the vicinity of, e.g., between, the first and second tube outlets, said initial droplet comprising the first liquid composition and the second liquid composition separated by the interfacial polyelectrolyte complex within the initial droplet. In various embodiments, the formation of the initial droplet in the vicinity of the first and second tube outlets may facilitate the flow of the first liquid composition into the second tube outlet via capillary action to form the interfacial polyelectrolyte complex within the second tube. In various embodiments, the first mechanism further comprises attaching the initial droplet to the target location on the surface of the rotatable collector. For example, the initial droplet may be allowed to depart from its suspended position and descend under the influence of gravity to contact the target location. In various embodiments, the rotatable collector may or may not be rotating prior to attachment of the initial droplet on the target location on the surface of the rotatable collector. In various embodiments, the initial droplet that is attached to the target location on the surface of the rotatable collector is connected to the first and second tube outlets via a fibre drawn from the interfacial polyelectrolyte complex within the second tube and/or within the initial droplet. In various embodiments, the first mechanism further comprises applying a drawing force by rotation of the rotatable collector to continuously draw the fibre from the interfacial polyelectrolyte complex within the second tube and optionally, from the interfacial polyelectrolyte complex within the initial droplet that is attached on the surface of the rotatable collector. In various embodiments, the first mechanism further comprises facilitating a dispensing force provided by the second dispensing rate to eject the fibre from the interfacial polyelectrolyte complex within the second tube. In various embodiments, the fibre that is ejected from the interfacial polyelectrolyte complex within the second tube is configured to attach to the target position on the surface of the rotatable collector while remaining connected to the first and second tube outlets. In various embodiments, there may be no subsequent droplets other than the initial droplet attached to the target location on the surface of the rotatable collector. In various embodiments, the first mechanism may advantageously produce fine fibres having an average diameter falling in the range of from about 0.05 mm to about 0.50 mm.

Without wishing to be bound by theory, it is believed that a balance of outward flow of the second liquid composition and inward flow of the first liquid composition via the second tube outlet may lead to a laminar flow within the second tube. The outward flow of the second liquid composition may be controlled by the second dispensing rate, which provides a dispensing force (the “Push”). The drawing of a distal part of the fibre that is adhered to the rotatable collector may be controlled by rotation of the rotatable collector, which applies a drawing force for drawing and collecting the fibre (the “Pull”). By regulating the “Push” and “Pull” (i.e., the dispensing force and the drawing force) with the presence of the first liquid composition within the second tube, the fibre, e.g., fine IPC fibre, is ejected from the interfacial polyelectrolyte complex. In various embodiments, the ejected fibre may be further crosslinked via bathing in a suspended droplet comprising the first and second liquid compositions. In various embodiments therefore, the system or associated method disclosed herein may advantageously achieve continuous spooling of fine fibres (e.g., fibres having an average diameter falling in the range of from about 0.05 mm to about 0.50 mm). In various embodiments, the system or associated method disclosed herein may be capable of producing a continuous length of fibres.

In various embodiments, the system or associated method disclosed herein may be configured to create the fibre via a second mechanism, where the first tube is positioned in proximity with respect to the second tube to allow the first liquid composition dispensed from the first tube outlet and the second liquid composition dispensed from the second tube outlet to contact each other to form a droplet (e.g., an initial droplet, suspended in the vicinity of, e.g., between, the first and second tube outlets), said droplet comprising the first liquid composition and the second liquid composition separated by the interfacial polyelectrolyte complex within the droplet, and where the fibre is drawn from the interfacial polyelectrolyte complex within the droplet when the droplet travels and contacts with a target location on a surface of the rotatable collector.

In various embodiments, the second mechanism comprises forming an initial droplet in the vicinity of, e.g., between, the first and second tube outlets, said initial droplet comprising the first liquid composition and the second liquid composition separated by the interfacial polyelectrolyte complex within the initial droplet. In various embodiments, the second mechanism further comprises attaching the initial droplet to the target location on the surface of the rotatable collector. For example, the initial droplet may be allowed to depart from its suspended position and descend under the influence of gravity to contact the target location. In various embodiments, the rotatable collector may or may not be rotating prior to attachment of the initial droplet on the target location on the surface of the rotatable collector. In various embodiments, the initial droplet that is attached to the target location on the surface of the rotatable collector is connected to the first and second tube outlets via a fibre drawn from the interfacial polyelectrolyte complex within the initial droplet. In various embodiments, the second mechanism further comprises applying a drawing force by rotation of the rotatable collector to continuously draw the fibre from the interfacial polyelectrolyte complex within the initial droplet that is attached on the surface of the rotatable collector. In various embodiments, the second mechanism further comprises facilitating a dispensing force by dispensing the first and second liquid compositions such that subsequent droplets are consecutively formed in the vicinity of the first and second tube outlets and allowed to roll along the fibre formed by the initial droplet and attach to the surface of the rotatable collector when in rotation. In various embodiments, the subsequent droplets may be directly or indirectly attached to the surface of the rotatable collector. For example, a subsequent droplet may be indirectly attached to the surface of the rotatable collector by attaching to a fibre that is drawn from a preceding droplet and collected on the surface of the rotatable collector. In various embodiments, a fibre is drawn from the interfacial polyelectrolyte complex within each subsequent droplet that is attached on the surface of the rotatable collector. In various embodiments, the first and second tubes are configured to have a droplet dispensing rate that is coordinated with a rotational speed of the rotatable collector, such that a second droplet attaches to the surface of the rotatable collector before fibre arising from a first droplet is broken. This advantageously enables continuous laying down of fibre and a continuous fibre layer on the cylinder. In various embodiments, the second mechanism may produce fibres having a relatively larger diameter as compared to the first mechanism.

In various embodiments, the system or associated method disclosed herein may be configured to create the fibre, e.g., continuous fibre, via the first mechanism and/or second mechanism. In various embodiments, fibre creation via the first and second mechanism may occur concurrently or separately within the same system setup. For example, this may be achieved by controlling parameters such as the dispensing rates of the first and/or second tubes, viscosities of the first and/or second liquid compositions, tubing diameter which affects velocity of the ejecting first and/or second liquid compositions etc. In one example, the dispensing rates of the first and second liquid compositions may be lowered to promote fibre formation via the first mechanism or lowered such that fibre formation only occurs via the first mechanism. In another example, the dispensing rates of the first and second liquid compositions may be raised to promote fibre formation via the second mechanism or raised such that fibre formation only occurs via the second mechanism. In yet another example, the the dispensing rates of the first and second liquid compositions may be optimised to promote simultaneous/concurrent fibre formation via the first and second mechanism.

In various embodiments, the system or associated method disclosed herein may be applied in the production of meat substitutes/analogues. The inherent characteristics of IPC-drawn fibres, such as being comprised of finer nuclear fibres, allow it to approximate the microstructure of muscle and make it suitable for fabrication of meat analogues via encapsulation of proteins and other food components. In various embodiments, the system or associated method disclosed herein may advantageously provide a scalable and more efficient approach to make fibrous meat-like constructs. In various embodiments, the system or associated method disclosed herein may be performed at ambient temperature and pressure, e.g., room temperature of from about 20° C. to about 30° C., and standard atmospheric pressure of about 1 atm. This may advantageously facilitate incorporation of ingredients, e.g., bioactive ingredients that are sensitive to temperature and pressure, and maintain nutritional value of the ingredients in the meat substitutes.

In various embodiments, the first and/or second tubes may be substantially linear (i.e., substantially straight) tubes. This may advantageously ensure a substantially laminar flow of the liquid compositions, enable fine control of the dispensing rates of the liquid compositions, and may reduce the likelihood of clogging within the tubes. In various embodiments, the first tube further comprises a first tube inlet for receiving the first liquid composition. In various embodiments, the first tube comprises a first lumen extending between the first tube inlet and first tube outlet, said first lumen being configured to allow fluid communication between the first tube inlet and first tube outlet. In various embodiments, the second tube further comprises a second tube inlet for receiving the second liquid composition. In various embodiments, the second tube comprises a second lumen extending between the second tube inlet and second tube outlet, said second lumen being configured to allow fluid communication between the second tube inlet and second tube outlet. In various embodiments, the first lumen and/or second lumen may have a uniform diameter. In various embodiments, the first lumen and/or second lumen may have a non-uniform diameter.

In various embodiments, the first tube may have an inner diameter (i.e., diameter of the first lumen) falling in the range of from about 0.10 mm to about 5.00 mm. In some embodiments, the first tube may have an inner diameter falling in the range of from about 0.25 mm to about 4.00 mm. In some embodiments, the first tube may have an inner diameter falling in the range of from about 0.50 mm to about 1.50 mm. In various embodiments, the second tube may have an inner diameter (i.e., diameter of the second lumen) falling in the range of from about 0.10 mm to about 5.00 mm. In some embodiments, the second tube may have an inner diameter falling in the range of from about 0.25 mm to 4.00 mm. In some embodiments, the second tube may have an inner diameter falling in the range of from about 0.50 mm to about 1.50 mm.

In various embodiments, the first tube and second tube may have the same inner diameter. In various embodiments, the first tube and second tube may have different inner diameters. In various embodiments, the first tube may have a larger inner diameter than that of the second tube. In various embodiments, the first tube may have a smaller inner diameter than that of the second tube. In various embodiments, the first tube and second tube may have an inner diameter falling in the range with start and end points independently selected from the following group of numbers: 0.10, 0.15, 0.20, 0.25, 0.30, 0.35, 0.40, 0.45, 0.50, 0.55, 0.60, 0.65, 0.70, 0.75, 0.80, 0.85, 0.90, 0.95, 1.00, 1.05, 1.10, 1.15, 1.20, 1.25, 1.30, 1.35, 1.40, 1.45, 1.50, 1.55, 1.60, 1.65, 1.70, 1.75, 1.80, 1.85, 1.90, 1.95, 2.00, 2.05, 2.10, 2.15, 2.20, 2.25, 2.30, 2.35, 2.40, 2.45, 2.50, 2.55, 2.60, 2.65, 2.70, 2.75, 2.80, 2.85, 2.90, 2.95, 3.00, 3.05, 3.10, 3.15, 3.20, 3.25, 3.30, 3.35, 3.40, 3.45, 3.50, 3.55, 3.60, 3.65, 3.70, 3.75, 3.80, 3.85, 3.90, 3.95, 4.00, 4.05, 4.10, 4.15, 4.20, 4.25, 4.30, 4.35, 4.40, 4.45, 4.50, 4.55, 4.60, 4.65, 4.70, 4.75, 4.80, 4.85, 4.90, 4.95, and 5.00 mm.

In various embodiments, the first tube may be positioned relative to the second tube such that the first tube outlet is at the same level as the second tube outlet. In various embodiments, the first tube may be positioned relative to the second tube such that the first tube outlet is a higher level than the second tube outlet (i.e., the second tube outlet is positioned at a lower level as compared to the first tube outlet). In various embodiments, positioning of the first tube outlet at the same as, or higher level than, the second tube outlet may advantageously promote flow of the first liquid composition dispensed from the first tube into the second tube outlet via capillary action. In various embodiments, the first tube outlet and second tube outlet may be spaced apart such that there is no physical contact between the first tube outlet and second tube outlet.

In various embodiments, the first tube may be positioned at an angle with respect to the second tube, wherein the first and second tube outlets are positioned proximal to the vertex formed by the longitudinal axes of the first and second tubes (i.e., the vertex of said angle). In various embodiments, the angle between the first and second tubes may fall in the range of from about 0° to about 120°. In some embodiments, the angle between the first and second tubes is 0°, i.e., the first and second tubes are substantially parallel to each other. In some embodiments, the first tube is positioned substantially parallel to the vertical axis and the second tube may be positioned at an angle falling in the range of from about 0° to about 60° with respect to the first tube. In some embodiments, both the first and second tubes are positioned at an angle greater than 0° with respect to the vertical axis (i.e., both tubes are not parallel to the vertical axis), and the second tube may be positioned at an angle falling in the range of from about 0° to about 120° with respect to the first tube. For example, each tube may be positioned at an angle of about 60° with respect to the vertical axis, such that the angle between the first and second tubes is 120°. In various embodiments, the angle between the first and second tubes may fall in the range with start and end points selected from the following group of numbers: 0, 5, 10, 15, 20, 25, 30, 35, 40, 45, 50, 55, 60, 65, 70, 75, 80, 85, 90, 95, 100, 105, 110, 115, and 120°. In various embodiments, positioning of the first tube at an angle with respect to the second tube may advantageously promote flow of the first liquid composition dispensed from the first tube into the second tube outlet via capillary action.

In various embodiments, the first and/or second tubes may be rigid tubes. In various embodiments, the first and/or second tubes may be flexible tubes. In various embodiments, the first and second tubes may be made of any suitable material, including but not limited to, plastic, metal, and glass. In various embodiments, plastic materials suitable for making the first and second tubes may include but are not limited to polyurethane (PUR or PU), polyamide (PA or Nylon), polypropylene (PP), polyvinylchloride (PVC), polytetrafluoroethylene (PTFE or Teflon), perfluoroalkoxy (PFA), polyethylene (PE), and combinations thereof.

In various embodiments, the system may further comprise a first reservoir for holding the first liquid composition and a second reservoir for holding the second liquid composition. In various embodiments, the first reservoir may be coupled to the first tube via the first tube inlet. In various embodiments, the second reservoir may be coupled to the second tube via the second tube inlet. In various embodiments, the first and second reservoirs may be directly or indirectly coupled to the first and second tube inlets. In various embodiments, the first and second reservoirs may be in the form of a syringe or a container for holding the liquid composition. In various embodiments, the first and/or second reservoirs may comprise a mixer/mixing element for mixing the liquid composition contained therein. This may advantageously ensure that the liquid composition, e.g., suspension, is homogenously mixed prior to being dispensed at the tube outlets.

In various embodiments, the system may further comprise one or more pump devices for delivering the first and second liquid compositions from the first and second reservoirs to be dispensed via the first and second tube outlets, respectively. In various embodiments, the one or more pump devices may be configured to provide a steady flow of the liquid compositions within the first and second tubes. In various embodiments, the pump device may be any suitable pump, including but not limited to syringe pump, peristaltic pump, pneumatic pump, piston pump, reciprocating pump, diaphragm pump, screw pump, rotary lobe pump, tooth wheel pump, plunger pump, or any other suitable pump known in the art.

In various embodiments, the first and second dispensing rates at the first and second tube outlets may be determined by the one or more pump devices. In various embodiments, the first dispensing rate and the second dispensing rate are configured to be the same. In various embodiments, the first dispensing rate is configured to be different from the second dispensing rate. In various embodiments, the first dispensing rate is configured to be higher than the second dispensing rate. In various embodiments, the first dispensing rate is configured to be lower than the second dispensing rate. In various embodiments, the first and second dispensing rates may fall in the range of from about 0.1 ml/min to about 1.0 ml/min. In some embodiments, the first and second dispensing rates may fall in the range of from about 0.1 ml/min to about 0.8 ml/min. In some embodiments, the first and second dispensing rates may fall in the range of from about 0.3 ml/min to about 0.5 ml/min. In various embodiments, the first dispensing rate and second dispensing rate may fall in the range with start and end points selected from the following group of numbers: 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, and 1.00 ml/min.

In various embodiments, the rotatable collector takes the form of an elongate body having a longitudinal axis, a first end, a second end opposite the first end, and an external surface defined between the first and second end. In various embodiments, the first and second ends of the elongate body define a cross-sectional shape/profile of the rotatable collector. In various embodiments, the rotatable collector takes the form of a single elongate body. In various embodiments, the rotatable collector is configured to rotate about its longitudinal axis, i.e., its rotational axis/axis of rotation. In various embodiments, the longitudinal axis of the rotatable collector is aligned substantially parallel to a horizontal plane with respect to gravity. In various embodiments, the longitudinal axis of the rotatable collector is aligned substantially perpendicular to the direction of gravity. In various embodiments, the longitudinal axis of the rotatable collector is substantially perpendicular to a fibre drawing axis. In various embodiments, the fibre drawing axis is defined as an imaginary line extending from the first and second tube outlets to the target location on the surface of the rotatable collector. In various embodiments, the longitudinal axis of the rotatable collector is substantially perpendicular to a fibre axis. In various embodiments, the fibre axis may refer to a longitudinal axis of the fibre when the fibre is substantially straight. In various embodiments, the fibre axis may refer to an imaginary line that is tangent to a point of the fibre when the fibre is collected on the surface of the rotatable collector, e.g., curved surface of a cylinder. In various embodiments, the direction of rotation of the rotatable collector relative to the direction in which fibre is being drawn may advantageously facilitate continuous spooling/winding/coiling of the fibre on the rotatable collector.

In various embodiments, the rotatable collector is configured to facilitate a drawing force that allows the fibre to continuously increase in length, by rotating in a direction to continuously draw the fibre from the interfacial polyelectrolyte complex. Accordingly, the drawing force may be derived from the rotation force. In various embodiments, a continuous length of the fibre is configured to be drawn and collected on the rotatable collector. In other words, the fibre is not substantially broken when being drawn and collected on the rotatable collector. In various embodiments, the fibre is coiled/wound/spooled on the external surface of the rotatable collector. In various embodiments, successive newly formed portions of the fibre may be overlaid in a direction parallel to the surface of the rotatable collector and/or in a direction perpendicular to the surface of the rotatable collector. In various embodiments, successive newly formed portions of the fibre may be substantially parallel to previously formed portions of the fibre that is collected on the surface of the rotatable collector.

In various embodiments, the rotatable collector takes the form of a drum or cylinder, e.g., right circular cylinder. In various embodiments, the rotatable cylinder comprises a cylindrical surface having a circular cross-section and optionally, a first base member and a second base member disposed at respective first and second ends of the cylinder. In various embodiments, the cylinder may be a closed cylinder or an open cylinder. In various embodiments, the rotatable cylinder is configured to rotate about its longitudinal/cylindrical axis that is aligned to be substantially parallel to a horizontal plane. In various embodiments, the rotatable collector, e.g., in the form of a single cylinder, may provide a perforated or meshed external surface defined between the first and second ends, such that sections of the fibres are suspended between two points of contact/adherence when laid on the surface of the rotatable collector during spooling. In various embodiments, the rotatable collector, e.g., in the form of a single cylinder, may provide a continuous surface (i.e., with no perforations) defined between the first and second ends, that allows successive droplets to attach on its circumference while the collector is rotating, such that a second droplet attaches before fibre arising from a first droplet is broken. In various embodiments, the rotatable collector (which could be continuous, perforated or meshed) may provide a surface with sufficient area for attachment of successive droplets such that a second, third, or following droplet attaches before fibre arising from a first droplet is broken. Such a surface may be advantageously provided by a rotatable collector having a single elongate body, as opposed to a rotatable collector having multiple elongate bodies. In various embodiments, successive droplets may be directly or indirectly attached to the surface of the rotatable collector. For example, successive droplets may be directly attached to the surface of the rotatable collector. For example, successive droplets may be attached to a fibre from a preceding droplet which is collected on the surface of the rotatable collector (i.e., indirectly attached to the surface of the rotatable collector. It will be appreciated that the rotatable collector is not limited to the form of a circular cylinder. In various embodiments, the rotatable collector may take the form of an elongate body with a cross-sectional shape of an ellipse/oval shape, a star shape, a polygonal shape, e.g., square, pentagon, and the like.

In various embodiments, the target location on the surface of the rotatable collector may refer to a point or an area or region on the surface of the rotatable collector. In various embodiments, the target location on the surface of the rotatable collector may refer to a point or an area or region on the surface of the rotatable collector for initially contacting the fibre. In various embodiments, the target location is determined by virtue of the positions of the first and second tubes relative to the position of the rotatable collector. In various embodiments, the target location is on the external surface between the first and second ends of the rotatable collector. In various embodiments, the target location is on a curved surface, e.g., curved external surface of the rotatable collector. In various embodiments, the curved surface is a surface of a cylinder.

In various embodiments, the rotatable collector is positioned relative to the first and second tubes, such that the fibre moves in a direction away from the outlets of the first and second tubes upon contacting the target location on the surface of the rotatable collector when the rotatable collector is in rotation. In various embodiments, the rotatable collector may be positioned under the first and second tubes, such that the fibre moves in a downward direction away from the outlets of the first and second tubes and towards the target location on the surface of the rotatable collector when the rotatable collector is in rotation.

In various embodiments, the rotatable collector, e.g., in the form of a cylinder, may be positioned relative to the first and second tubes such that, when viewed from one end of the rotatable collector, e.g., cylinder, the first and second tubes are at a position falling between a 9 to 12 o'clock position with respect to the cross section of the rotatable collector, e.g., circular cross-section of the cylinder. In various embodiments, when the first and second tubes are at a position falling between the 9 to 12 o'clock position, the target location where the fibre attaches falls between the 9 to 12 o'clock position on the surface of the rotatable collector. In some embodiments, the first and second tubes may be at a position falling between a 10 to 11 o'clock position with respect to the cross-section of the rotatable collector. In various embodiments, when the first and second tubes are at a position falling between the 9 to 12 o'clock position, the rotatable collector is configured to rotate in an anti-clockwise direction to continuously draw the fibre from the interfacial polyelectrolyte complex and allow the fibre to continuously increase in length.

In various embodiments, the rotatable collector, e.g., in the form of a cylinder, may be positioned relative to the first and second tubes such that, when viewed from the same end of the rotatable collector, e.g., cylinder, the first and second tubes are at a position falling between a 12 to 3 o'clock position with respect to the cross-section of the rotatable collector, e.g., circular cross-section of the cylinder. In various embodiments, when the first and second tubes are at a position falling between the 12 to 3 o'clock position, the target location where the fibre attaches falls between the 12 to 3 o'clock position on the surface of the rotatable collector. In some embodiments, the first and second tubes may be at a position falling between a 1 to 2 o'clock position with respect to the cross-section of the rotatable collector. In various embodiments, when the first and second tubes are at a position falling between the 12 to 3 o'clock position, the rotatable collector is configured to rotate in a clockwise direction to continuously draw the fibre from the interfacial polyelectrolyte complex and allow the fibre to continuously increase in length.

It will be appreciated that when the first and second tubes are at a position falling at the 12 o'clock position, the rotatable collector may rotate either in a clockwise direction or an anti-clockwise direction, as both directions result in continuous drawing of the fibre from the interfacial polyelectrolyte complex and allow the fibre to continuously increase in length.

In various embodiments, the first and second tube outlets may be positioned at a distance falling in the range of from about 0.1 cm to about 10 cm away from the surface of the rotatable collector. In some embodiments, the first and second tube outlets may be positioned at a distance falling in the range of from about 0.5 cm to about 5 cm away from the surface of the rotatable collector. In some embodiments, the first and second tube outlets may be positioned at a distance falling in the range of from about 1 cm to about 3 cm away from the surface of the rotatable collector. In various embodiments, the first and second tube outlets may be independently positioned at a distance away from the surface of the rotatable collector, said distance falling in the range with start and end points selected from the following group of numbers: 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, and 10 cm.

In various embodiments, the system further comprises a motor coupled to the rotatable cylinder, said motor being configured to drive the rotation of the rotatable cylinder about its longitudinal axis. In various embodiments, the drawing force facilitated by the rotatable collector may depend on the speed of rotation/rotational speed of the rotatable collector. In various embodiments, the rotatable collector may be configured to rotate at a rotational speed falling in the range of from about 0.5 revolutions per minute (RPM) to about 10 RPM. In some embodiments, the rotatable collector may be configured to rotate at a rotational speed falling in the range of from about 1 RPM to about 8 RPM. In some embodiments, the rotatable collector may be configured to rotate at a rotational speed falling in the range of from about 3 RPM to about 8 RPM. In some embodiments, the rotatable collector may be configured to rotate at a rotational speed falling in the range of from about 5 RPM to about 6 RPM. In various embodiments, the rotatable collector may be configured to rotate at a rotational speed falling in the range with start and end points selected from the following group of numbers: 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, and 10 RPM.

In various embodiments, the rotatable collector in the form of a cylinder may have a diameter falling in the range of from about 50 mm to about 300 mm. In one embodiment, the rotatable collector in the form of a cylinder has a diameter of about 100 mm. In various embodiments, the rotatable collector in the form of a cylinder may have a diameter falling in the range with start and end points selected from the following group of numbers: 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, and 300 mm.

In various embodiments, the system further comprises a frame member for allowing the rotatable collector to be mounted/supported thereon. In various embodiments, the frame member is configured to allow the rotatable collector to rotate while keeping the longitudinal axis of the rotatable collector substantially parallel to a horizontal plane.

In various embodiments, the system further comprises a support member coupled to the first and second tubes, said support member configured to maintain the positions/distance of the first and second tube outlets relative to the surface of the rotatable collector. In various embodiments, the support member may be configured to move the first and second tubes along an axis that is substantially parallel to the longitudinal axis of the rotatable collector. In other words, the first tube and second tube may be configured to be movable relative to the rotatable collector along an axis that is substantially parallel to the longitudinal axis of the rotatable collector.

In various embodiments, the first and second tubes may be configured to dispense the first and second liquid compositions from a fixed position relative to the rotatable collector while the rotatable collector is in rotation. In other words, the first and second tubes remain in a stationary position relative to the rotatable collector while the rotatable collector is in rotation. This results in a vertical build-up of fibres, where newly drawn portions of the fibre are overlaid on top of previously drawn portions of the fibre in a plane perpendicular to the surface of the rotatable collector. In various embodiment, vertical build-up of fibres may be used to form a strand of fibrous construct with a desired thickness or diameter. In various embodiments, vertical build-up also describes the overlay of successive layers of drawn fibres in a plane perpendicular to the surface of the rotatable collector.

In various embodiments, the first and second tubes may be configured to dispense the first and second liquid compositions while moving along an axis that is substantially parallel to the longitudinal axis of the rotatable collector while the rotatable collector is in rotation. In other words, the first and second tubes are moving relative to the rotatable collector while the rotatable collector is in rotation. This results in a horizontal build-up of fibres, where newly drawn portions of the fibre are laid parallel to the surface of the rotatable collector and adjacent to previous drawn portions of the fibre collected on the rotatable collector. In various embodiments, horizontal build-up also describes laying of successive fibres parallel to the surface of the rotatable collector by controlled movement of the first and second tubes in a direction parallel to the longitudinal axis of the rotatable collector. In various embodiment, horizontal build-up of fibres may be used to form a layer of fibrous construct. In various embodiment, the first and second tubes may be configured to perform both vertical and horizontal build-up of fibres to form a layer of fibrous construct with desired dimensions, e.g, length, width, thickness.

In various embodiments, the first and second tubes may be configured to dispense the first and second liquid compositions while moving in a first direction along an axis that is substantially parallel to the longitudinal axis of the rotatable collector while the rotatable collector is in rotation. In various embodiments, the first and second tubes may be configured to dispense the first and second liquid compositions while moving in a second opposite direction (i.e., opposite to the first direction) along the axis that is substantially parallel to the longitudinal axis of the rotatable collector while the rotatable collector is in rotation. For example, the first and second tubes may be configured to move in the first direction and thereafter reverse to move in the second direction after reaching one end of the rotatable collector.

In various embodiments, the system may further comprise an elongate support member having a longitudinal axis arranged to be substantially parallel to the longitudinal axis of the rotatable collector. In various embodiments, the elongate support member comprises a plurality of the first tube and second tube coupled thereto. For example, the elongate support member may comprise a plurality of receptacles, e.g., holes, for accommodating the plurality of the first and second tubes. In various embodiments, the elongate support member may be configured to be movable along its longitudinal axis relative to the rotatable collector. In various embodiments, the elongate support member may be configured to move the plurality of first and second tubes along its longitudinal axis. In various embodiments, the plurality of the first tube and second tube may be configured to dispense the first and second liquid compositions simultaneously. In various embodiments, the plurality of the first tube and second tube may be configured to dispense the first and second liquid compositions at the same or different operating parameters, e.g., dispensing rates, ingredients of the first and second compositions etc. For example, all the first tubes in the plurality of first tubes may be configured to dispense the first liquid composition at the same first dispensing rate and all the second tubes in the plurality of second tubes may be configured to dispense the second liquid composition at the same second dispensing rate. For example, a first subset of the first and second tubes may have different dispensing rates and/or liquid compositions (e.g., viscosity, ingredients etc.) from a second subset of the first and second tubes within the plurality of first and second tubes.

In various embodiments, the plurality of first and second tubes may be configured to dispense the first and second liquid compositions from a fixed position relative to the rotatable collector while the rotatable collector is in rotation. In other words, the plurality of first and second tubes remain in a stationary position relative to the rotatable collector while the rotatable collector is in rotation, thereby resulting in a vertical build-up of fibres.

In various embodiments, the plurality of first and second tubes may be configured to dispense the first and second liquid compositions while moving an axis that is substantially parallel to the longitudinal axis of the rotatable collector while the rotatable collector is in rotation. In other words, the plurality of first and second tubes are moving relative to the rotatable collector while the rotatable collector is in rotation, thereby resulting in a horizontal build-up of fibres.

In various embodiments, the plurality of first and second tubes may be configured to dispense the first and second liquid compositions while moving in a first direction along its longitudinal axis relative to a rotating collector. In various embodiments, the plurality of first and second tubes may be configured to dispense the first and second liquid compositions while moving in a second opposite direction (i.e., opposite to the first direction) along its longitudinal axis relative to a rotating collector. For example, the plurality of first and second tubes may be configured to move in the first direction and thereafter reverse to move in the second direction after reaching one end of the rotatable collector.

In various embodiments, the support member is configured to move along the axis that is substantially parallel to the longitudinal axis of the rotatable collector, and the elongate support member is configured to move along its longitudinal axis at a speed falling in the range of from about 0.1 cm/min to about 1 cm/min. In various embodiments, the support member and elongate support member are configured to move at a speed falling in the range selected from the following group of numbers: 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, and 1 cm/min.

In various embodiments, the system may further comprise a bath container having an interior space for holding liquid and an open top for receiving the rotatable collector. In various embodiments, the rotatable collector is positioned in the interior space of the bath container such that the rotatable collector is partially submerged when the bath container is filled with liquid. In various embodiments, the bath container is configured to hold a bath liquid composition comprising ingredients, nutrients and/or supplements for modifying the fibre. In various embodiments, the bath container may comprise a mixer/mixing element for mixing the liquid contained therein. In various embodiments, the rotatable collector may comprise one or more mixer/mixing element attached to its surface, such that the one or more mixer/mixing elements mixes the liquid in the bath container via rotation of the rotatable collector.

In various embodiments, the system may further comprise a guide member for guiding flow of liquid in a designated direction. In various embodiments, the guide member may comprise receptacles, e.g., hollow channels, for receiving the first and second tubes, respectively. In various embodiments, the guide member may comprise a first and a second receptacle for receiving the first and second tubes, respectively, said first and second receptacles orientated such that the first and second tubes are in proximity to, and at a desired angle with respect to each other, when inserted into the receptacles. In various embodiments, the guide member may further comprise a surface with one or more grooves formed thereon, said one or more grooves being configured to guide the flow of liquid. In various embodiments, the one or more grooves may be configured to be positioned in proximity to the first and second tube outlets when the first and second tubes are inserted into the receptacles, to guide the first and second liquid compositions dispensed therefrom to flow (e.g., in the form of droplet(s) or a stream of liquid flowing along the fibre) towards the target location on the surface of the rotatable collector. In various embodiments, the guide member may comprise a groove tip disposed at one end of the groove for focusing the first and second liquid composition prior to leaving the guide member. For example, the guide member may comprise a V-shaped groove tip such that a resulting droplet of the first and second liquid compositions is allowed to focus/accumulate at an apex/vertex of the V-shaped groove tip prior to leaving the guide member. For example, the first liquid composition or part thereof may be guided along the one or more grooves to flow into the second tube outlet via capillary action. For example, the first and second liquid compositions may be guided to flow down along the fibre for the first mechanism of fibre creation. For example, the first and second liquid compositions may be guided to roll down in the form of droplets along the fibre for the second mechanism of fibre formation. In various embodiments, the structural features of the guide member may be partially or entirely integrated/combined with the support member and elongate support member such that the support member and elongate support member also comprise the above feature(s) of the guide member.

In various embodiments, the system may further comprise one or more additional tubes for dispensing additional liquid compositions. For example, the system may comprise a third tube having a third tube outlet for dispensing a third liquid composition at a third dispensing rate. In various embodiments, the one or more additional tubes may be constructed in a similar manner as the first and second tube, e.g., having similar inner diameter, dispensing rate, and configured to be movable with respect to the rotatable collector. In various embodiments, the one or more additional tubes may be positioned relative to the rotatable collector at a different location than the first and second tubes. For example, the first and second tubes may be at a position falling between a 9 to 12 o'clock position with respect to the cross-section of the rotatable collector (e.g., circular cross-section of the cylinder), and the third tube may be at a position falling between a 12 to 3 o'clock position with respect to the cross-section of the rotatable collector. In various embodiments, the one or more additional tubes may be configured to dispense the one or more additional liquid compositions for modifying the fibre(s) that are drawn and collected on the rotatable collector. This may advantageously enhance the properties, e.g., mechanical properties of the fibre(s). For example, the third liquid composition may comprise a crosslinker for further crosslinking the fibre(s) that are drawn and collected on the rotatable collector.

In various embodiments, the components of the system as disclosed herein are non-toxic, corrosion-resistant, chemically inert, easily cleanable, replaceable and/or sterilisable. In various embodiments, parts of the system that come into contact (directly or indirectly) with the liquid compositions and fibres formed therefrom are non-toxic, corrosion-resistant, chemically inert, easily cleanable, replaceable, and/or sterilisable, e.g., the first and second tubes, the first and second reservoirs, and the rotatable collector. In various embodiments, the whole system is non-toxic, corrosion-resistant, chemically inert, easily cleanable, replaceable, and/or sterilisable. Sterilisation may be performed using suitable materials and techniques known in the art, e.g., ethylene oxide, gamma or electron beam irradiation, plasma, or autoclave sterilization. Advantageously, this allows the system to be suitable for food manufacturing applications, e.g., for manufacturing artificial meat/meat substitutes.

In various embodiments, the system may further comprise a processing unit for controlling the various components of the system and the operating parameters for executing a method of creating the fibre. In various embodiments, the processing unit may be configured to control the first and second dispensing rates of the first and second liquid compositions. In various embodiments, the processing unit may be configured to control the speed of rotation of the rotatable collector. In various embodiments, the processing unit may be configured to control the movements and positions of the first and second tubes, or the elongate support member comprising the plurality of the first and second tubes, in relation to the rotatable cylinder. In various embodiments, the processing unit may be configured to coordinate the first and second dispensing rates of the first and second liquid compositions, the speed of rotation of the rotatable collector, and/or the movements and positions of the first and second tubes or the elongate support member, to ensure that continuous spooling of fibres is achieved.

### Method of Creating a Fibre

In various embodiments, there is provided a method of creating a fibre, the method comprising, positioning a first tube in proximity with respect to a second tube; dispensing a first liquid composition from the first tube having a first tube outlet at a first dispensing rate; dispensing a second liquid composition from the second tube having a second tube outlet at a second dispensing rate; forming an interfacial polyelectrolyte complex between the first liquid composition from the first tube and the second liquid composition from the second tube; drawing a fibre from the interfacial polyelectrolyte complex; and applying a drawing force by rotating the rotatable collector about its longitudinal axis that is aligned substantially parallel to a horizontal plane to draw and collect the fibre.

In various embodiments, the step of forming the interfacial polyelectrolyte complex and drawing the fibre from the interfacial polyelectrolyte complex comprise a first mechanism of allowing the first liquid composition dispensed from the first tube outlet to flow into the second tube outlet via capillary action to form the interfacial polyelectrolyte complex with the second liquid composition within the second tube, ejecting the fibre from the interfacial polyelectrolyte complex through a dispensing force provided by the second dispensing rate in the second tube, and contacting the fibre on a target location on a surface of the rotatable collector; and/or a second mechanism of allowing the first liquid composition dispensed from the first tube outlet and the second liquid composition dispensed from the second tube outlet to form a droplet (e.g., suspended between the first and second tube outlets), said droplet comprising the first and second liquid compositions separated by the interfacial polyelectrolyte complex within the droplet, allowing the droplet to travel and contact a target location on a surface of a rotatable collector, and drawing the fibre from the interfacial polyelectrolyte complex within the droplet that is in contact with the target location on the surface of the rotatable collector.

In various embodiments, the first mechanism comprises forming an initial droplet in the vicinity of, e.g., between, the first and second tube outlets, said initial droplet comprising the first liquid composition and the second liquid composition separated by the interfacial polyelectrolyte complex within the initial droplet. In various embodiments, the first mechanism further comprises attaching the initial droplet to the target location on the surface of the rotatable collector. In various embodiments, the first mechanism comprises allowing the initial droplet to travel and contact the target location on the surface of the rotatable collector. In various embodiments, the first mechanism further comprises applying a drawing force by rotating the rotatable collector to continuous draw the fibre from the interfacial polyelectrolyte complex within the second tube and optionally, from the interfacial polyelectrolyte complex within the initial droplet that is attached on the surface of the rotatable collector. In various embodiments, the first mechanism further comprises facilitating a dispensing force provided by the second dispensing rate to eject the fibre from the interfacial polyelectrolyte complex within the second tube. In various embodiments, the first mechanism may advantageously produce fine fibres having an average diameter falling in the range of from about 0.05 mm to about 0.50 mm.

In various embodiments, the second mechanism comprises forming an initial droplet in the vicinity of, e.g., between, the first and second tube outlets, said initial droplet comprising the first liquid composition and the second liquid composition separated by the interfacial polyelectrolyte complex within the initial droplet. In various embodiments, the second mechanism comprises allowing the initial droplet to travel and contact the target location on the surface of the rotatable collector. In various embodiments, the second mechanism further comprises attaching the initial droplet to the target location on the surface of the rotatable collector. In various embodiments, the second mechanism further comprises applying a drawing force by rotating the rotatable collector to continuously draw the fibre from the interfacial polyelectrolyte complex within the initial droplet that is attached on the surface of the rotatable collector. In various embodiments, the second mechanism further comprises facilitating a dispensing force by dispensing the first and second liquid compositions such that subsequent droplets are consecutively formed in the vicinity of the first and second tube outlets and allowed to roll along the fibre formed by the initial droplet and attach to the surface of the rotatable collector when in rotation. In various embodiments, the subsequent droplets may be directly or indirectly attached to the surface of the rotatable collector. For example, a subsequent droplet may be indirectly attached to the surface of the rotatable collector by attaching to a fibre that is drawn from a preceding droplet and collected on the surface of the rotatable collector. In various embodiments, the second mechanism further comprises drawing a fibre from the interfacial polyelectrolyte complex within each subsequent droplet that is attached on the surface of the rotatable collector. In various embodiments, the second mechanism may comprise coordinating a droplet dispensing rate with a rotational speed of the rotatable collector, such that a second droplet attaches to the surface of the rotatable collector before the fibre arising from a first droplet is broken. This advantageously enables continuous laying down of fibre and a continuous fibre layer on the cylinder.

In various embodiments, the method of creating a fibre relates to a method of fibre production and assembly. In various embodiments, the method is for creating an IPC fibre. In various embodiment, the method is for creating a continuous length of fibre, e.g., IPC fibre. In various embodiments, the fibre does not substantially break during fibre drawing and collection. In various embodiments, the method of creating a fibre may be used to create a fibre construct comprising a plurality of fibres. In various embodiments, the method of creating a fibre may be implemented using the system for creating a fibre as disclosed herein.

In various embodiments, the method as disclosed herein may be applied in the production of meat substitutes/analogues. In various embodiments, the method of creating the fibre is a non-toxic fabrication process. In various embodiments, the fibre and fibre construct created by the method as disclosed herein are safe for human and/or animal consumption. In various embodiments, the fibre may be manufactured using food-grade materials. In various embodiments, the fibre may be manufactured in a food processing facility. In various embodiments, the fibre and fibre construct are substantially free of pathogens. In various embodiments therefore, the fibre and fibre construct may be used or may be present in a food product without food safety concerns.

In various embodiments, the method may further comprise providing a first reservoir for holding the first liquid composition and a second reservoir for holding the second liquid composition. For example, the reservoirs may be in the form of syringes or containers for holding the liquid compositions. In various embodiments, the method may further comprise mixing the first and second liquid compositions in the first and second reservoirs, respectively. In various embodiments, the method may further comprise delivering the first and second liquid compositions from the first and second reservoirs to the first and second tubes to be dispensed via the first and second tube outlets, respectively. For example, one or more pump devices may be used to deliver the liquid compositions.

In various embodiments, the fibre that is drawn from the interfacial polyelectrolyte complex attaches to the target position on the surface of the rotatable collector while remaining connected to the first and second tube outlets. In various embodiments, the fibre is allowed to move in a direction away from the outlets of the first and second tubes upon contacting the target location on the surface of the rotatable collector when the rotatable collector is in rotation. In various embodiments, the rotatable collector takes the form of a drum, e.g., right circular cylinder. In one example, the fibre is allowed to contact the target location falling between the 9 to 12 o'clock position with respect to the cross-section of the rotatable collector, e.g., circular cross-section of the cylinder, on the surface of the rotatable collector, e.g., cylinder, when the rotatable collector is rotating in an anti-clockwise direction, when viewed from one end of the rotatable collector. In another example, the fibre is allowed to contact the target location falling between the 12 to 3 o'clock position with respect to the cross-section of the rotatable collector, e.g., circular cross-section of the cylinder, on the surface of the rotatable collector, e.g., cylinder, when the rotatable collector is rotating in a clockwise direction, when viewed from the same end of the rotatable collector. In various embodiments, the step of rotating the rotatable collector comprises drawing the fibre from the interfacial polyelectrolyte complex with a drawing force that allows the fibre to continuously increase in length.

In various embodiments, drawing and collecting the fibre comprise coiling/winding/spooling the fibre around the external surface defined between the first and second end of the elongate body of the rotatable collector, when the rotatable collector is in rotation. In various embodiments, the fibre is laid such that the fibre axis is substantially perpendicular to the longitudinal axis of the rotatable collector. In various embodiments, where the rotatable collector is in the form of a circular cylinder, the fibre is drawn and collected on a curved surface of the cylinder such that the fibre is substantially laid along a circumference of curved surface.

In various embodiments, a continuous length of the fibre may be wound around the rotatable collector as the rotatable collector rotates for at least a number of revolutions selected from the following group of numbers: 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30 revolutions. In various embodiments, the fibre may have a continuous length of at least 1 time, at least 2 times, at least 3 times, at least 4 times, at least 5 times, at least 6 times, at least 7 times, at least 8 times, at least 9 times, at least 10 times, at least 11 times, at least 12 times, at least 13 times, at least 14 times, at least 15 times, at least 16 times, at least 17 times, at least 18 times, at least 19 times, at least 20 times, at least 21 times, at least 22 times, at least 23 times, at least 24 times, at least 25 times, at least 26 times, at least 27 times, at least 28 times, at least 29 times, or at least 30 times the circumference of the rotatable collector. In various embodiments, the fibre may have a continuous length of from about 150 mm to about 950 mm. For example, when the rotatable collector is in the form of a cylinder with a diameter of about 50 mm, a single revolution may produce a continuous fibre with a length of about 150 mm (i.e., TT multipled by diameter of 50 mm). For example, when the rotatable collector is in the form of a cylinder with a diameter of about 300 mm, a single revolution may produce a continuous fibre with a length of about 950 mm. In various embodiments, the fibre may have a continuous length falling in the range with start and end points selected from the following group of numbers: 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, and 2000 mm. In various embodiments, the fibre may have a minimum continuous length of at least about 1200 mm, at least about 1250 mm, at least about 1300 mm, at least about 1350 mm, at least about 1400 mm, at least about 1450 mm, at least about 1500 mm, at least about 1550 mm, at least about 1600 mm, at least about 1650 mm, at least about 1700 mm, at least about 1750 mm, at least about 1800 mm, at least about 1850 mm, at least about 1900 mm, at least about 1950 mm, or at least about 2000 mm. It will be appreciated that the length of continuous fibre which can be drawn depends on factors such as the size (e.g., diameter) of the rotatable collector, rotational speed of the rotatable collector, inner diameters of the first and second tubes, volumes of the first and second liquid compositions available for fibre drawing etc, dispensing rates of the first and second liquid compositions, viscosities of the first and second liquid compositions etc.

In various embodiments, the fibre may have an average diameter falling in the range of from 0.01 mm to 0.50 mm. In some embodiments, the fibre may have an average diameter falling in the range of from 0.05 mm to 0.20 mm. In various embodiments, the fibre may have an average diameter falling in the range with start and end points selected from the following group of numbers: 0.01, 0.02, 0.03, 0.04, 0.05, 0.06, 0.07, 0.08, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, and 0.50 mm.

In various embodiments, rotation of the rotatable collector may advantageously allow excess liquid compositions dispensed from the first and second tube outlets to drip off the surface of the rotatable collector. Accumulation of excess liquid would otherwise lead to swelling of the fibres, leading to poor mechanical properties of the fibre construct.

In various embodiments, the first and/or second liquid composition may be in the form of a solution or a suspension. In various embodiments, the first and second liquid compositions may comprise ingredients suitable for use in fibre formation, e.g., IPC fibre formation. In various embodiments the first and second liquid compositions may comprise ingredients suitable for food manufacturing applications, e.g., manufacture of meat substitutes. In various embodiments, the first and second liquid compositions may comprise ingredients that are edible prior to fibre formation and after fibre formation. In various embodiments, the first and second liquid compositions may comprise ingredients that are biocompatible, biodegradable and/or food-grade.

In various embodiments, the first liquid composition comprises a crosslinker and the second liquid composition comprises a polyion. Examples of polyion solutions include but are not limited to sodium alginate, low methoxy pectin, hydroxyproline-rich glycoprotein, water-soluble chitin and chitosan. Examples of crosslinkers include but are not limited to calcium salts such as calcium chloride and calcium carbonate.

In various embodiments, the first liquid composition comprises a first polyion and the second liquid composition comprises a second polyion, wherein the first polyion and the second polyion are oppositely charged. Examples of oppositely charged polyion pairs include but are not limited to chitosan-alginate, chitosan-carboxymethylcellulose, water-soluble chitin-carboxymethylcellulose, chitosan-gellan, chitosan-poly(glutamic acid), water-soluble chitin-alginate, chitosan-hyaluronic acid, water soluble chitin-hyaluronic acid, chitosan-pectin, water-soluble chitin-pectin.

In various embodiments, the first and/or second liquid compositions may further comprise one or more materials such as food material (e.g., animal and/or plant protein, lipids, polysaccharides, dietary fibres etc), colour dye (e.g., egg yellow food colouring, cherry red food colouring), and supplements (e.g, vitamins and minerals). Examples of food material include but are not limited to pea protein isolate, lecithin, canola oil, coconut flour, corn flour, turmeric, cumin, salt, sweet potato starch and the like. In various embodiments, the one or more materials are edible. In various embodiments, the one or more materials are food-grade materials.

In various embodiments, the first and/or second liquid compositions may further comprise one or more materials such as food material (e.g., animal and/or plant protein, lipids, polysaccharides, dietary fibres etc), colour dye (e.g., egg yellow food colouring, cherry red food colouring), and supplements (e.g, vitamins and minerals). Examples of food material include but are not limited to pea protein isolate, lecithin, canola oil, coconut flour, corn flour, turmeric, cumin, salt, sweet potato starch and the like. In various embodiments, the one or more materials are edible. In various embodiments, the one or more materials are food-grade materials.

In various embodiments, the first and/or second liquid compositions may comprise at least one polyion having a concentration falling in the range of from about 0.5% (w/v) to about 2.5% (w/v) of the first and/or second liquid compositions, respectively. In various embodiments, the first and/or second liquid compositions may comprise at least one polyion having a concentration falling in the range with start and end points selected from the following group of numbers: 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, and 2.5% (w/v) of the first and/or second liquid compositions, respectively. For example, the first liquid composition may comprise from about 0.5% (w/v) to about 2.5% (w/v) of chitosan. For example, the second liquid composition may comprise from about 0.5 (w/v) to about 1.2% (w/v) of alginate which has an opposite charge to chitosan.

In various embodiments, the first or second liquid composition may comprise at least one crosslinker having a concentration falling in the range of from about 0.5% (w/v) to about 5% (w/v) of the first or second liquid composition, respectively. In various embodiments, the first or second liquid composition may comprise at least one crosslinker having a concentration falling in the range with start and end points selected from the following group of numbers: 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, and 5% (w/v) of the first or second liquid composition, respectively.

In various embodiments, the first and/or second liquid compositions may comprise at least one protein isolate having a concentration falling in the range of from about 5% (w/v) to about 20% (w/v) of the first or second liquid compositions, respectively. In various embodiments, the first or second liquid compositions may comprise at least one protein isolate having a concentration falling in the range with start and end points selected from the following group of numbers: 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, and 20 (w/v) of the first or second liquid compositions, respectively. Examples of protein isolates may include but are not limited to pea protein isolate and soy protein isolate.

In various embodiments, the first and/or second liquid compositions may comprise at least one flour having a concentration falling in the range of from about 5% (w/v) to about 20% (w/v) of the first or second liquid compositions, respectively. In various embodiments, the first or second liquid compositions may comprise at least one flour having a concentration falling in the range with start and end points selected from the following group of numbers: 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, and 20 (w/v) of the first or second liquid compositions, respectively. Examples of flour may include but are not limited to corn flour, potato flour, wheat flour, pea flour, and chickpea flour.

In various embodiments, the first and/or second liquid compositions may comprise at least one oil having a concentration falling in the range of from about 5% (v/v) to about 20% (v/v) of the first or second liquid compositions, respectively. In various embodiments, the first or second liquid compositions may comprise at least one oil having a concentration falling in the range with start and end points selected from the following group of numbers: 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, and 20 (v/v) of the first or second liquid compositions, respectively. Examples of oil may include but are not limited to canola oil, olive oil, coconut oil, peanut oil, and sesame oil.

In various embodiments, the first and/or second liquid compositions may comprise at least one gum having a concentration falling in the range of from about 0.5% (w/v) to about 2.5% (w/v) of the first or second liquid compositions, respectively. In various embodiments, the first or second liquid compositions may comprise at least one oil having a concentration falling in the range with start and end points selected from the following group of numbers: 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, and 2.5 (w/v) of the first or second liquid compositions, respectively. Examples of gum may include but are not limited to gum arabic.

In various embodiments, the first liquid composition is configured to have a different viscosity than the second liquid composition. In various embodiments, the first liquid composition is configured to have a lower viscosity than the second liquid composition.

In various embodiments, the first liquid composition may have a viscosity falling in the range from about 1 centiPoise (cPs) to about 20 cPs. In various embodiments, the viscosity of the first liquid composition may be configured to facilitate capillary action of the first liquid composition into the second tube outlet to form an interfacial polyelectrolyte complex within the second tube. In various embodiments, the first liquid composition may have a viscosity falling in the range with start and end points selected from the following group of numbers: 1, 2, 3, 4, 5, 6, 7, 8, 9, 10, 11, 12, 13, 14, 15, 16, 17, 18, 19, and 20 cPs. For example, the viscosity of the first liquid composition may be close to the viscosity of water at room temperature, i.e., about 1 cPs.

In various embodiments, the second liquid composition may have a viscosity falling in the range from about 5 to about 70,000 centiPoise (cPs). In some embodiments, the second liquid composition may have a viscosity falling in the range from about 5,000 to about 50,000 cPs. In various embodiments, the second liquid composition may have a viscosity falling in the range with start and end points selected from the following group of numbers: 5, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, 11000, 12000, 13000, 14000, 15000, 16000, 17000, 18000, 19000, 20000, 21000, 22000, 23000, 24000, 25000, 26000, 27000, 28000, 29000, 30000, 31000, 32000, 33000, 34000, 35000, 36000, 37000, 38000, 39000, 40000, 41000, 42000, 43000, 44000, 45000, 46000, 47000, 48000, 49000, 50000, 51000, 52000, 53000, 54000, 55000, 56000, 57000, 58000, 59000, 60000, 61000, 62000, 63000, 64000, 65000, 66000, 67000, 68000, 69000, and 70000 cPs.

In various embodiments, the method may further comprise maintaining the first and second tubes in a fixed position relative to the longitudinal axis of the rotatable collector while the rotatable collector is in rotation, such that newly drawn portions of the fibre are overlaid on top of previously drawn portions of the fibre collected on the rotatable collector.

In various embodiments, the method may further comprise moving the first tube and second tube relative to the rotatable collector along an axis that is substantially parallel to the longitudinal axis of the rotatable collector while the rotatable collector is in rotation, such that newly drawn portions of the fibre are laid adjacent to previously drawn portions of the fibre collected on the rotatable collector.

In various embodiments, the method further comprises dispensing the first and second liquid compositions from a plurality of the first and second tubes, wherein the plurality of the first and second tubes are coupled to an elongate support member having a longitudinal axis arranged to be substantially parallel to the longitudinal axis of the rotatable collector; and moving the elongate support member along its longitudinal axis relative to the rotatable collector.

In various embodiments, the method may further comprise moving the first and second tubes, or the plurality of first and second tubes, in a first direction along an axis that is substantially parallel to the longitudinal axis of the rotatable collector, when in rotation. In various embodiments, the method may further comprise moving the first and second tubes, or the plurality of first and second tubes, in a second opposite direction (i.e., opposite to the first direction) along the axis that is substantially parallel to the longitudinal axis of the rotatable collector, when in rotation. For example, the method may comprise moving the first and second tubes, or the plurality of first and second tubes, in the first direction, followed by moving in the second opposite direction after reaching one end of the rotatable collector.

In various embodiments, the method further comprises contacting the fibre collected on the rotatable collector with a bath liquid composition. In various embodiments, contacting the fibre collected on the rotatable collector with the bath liquid composition may comprise partially submerging the rotatable collector in a bath container holding the bath liquid composition. In various embodiments, rotation of the rotatable collector causes the fibre collected thereon to be submerged in the bath liquid composition held inside the bath container. In various embodiments, the method further comprises mixing the bath liquid composition in the bath container.

In various embodiments, the method may further comprise dispensing one or more additional liquid compositions from one or more additional tubes. For example, the method may comprise dispensing a third liquid composition from a third tube having a third tube outlet at a third dispensing rate. In various embodiments, the method may comprise modifying the fibre(s) that are drawn and collected on the rotatable collector with the one or more additional liquid compositions. This may advantageously enhance the properties, e.g., mechanical properties of the fibre(s). For example, the method may comprise further crosslinking the fibre(s) that are drawn and collected on the rotatable collector with the third liquid composition comprising a crosslinker.

In various embodiments, the method may further comprise a step of washing the fibre or fibre construct to remove unreacted components used during the process of creating the fibre, e.g., crosslinkers. The washing step may comprise rinsing the fibre or fibre construct at least once in a suitable solvent, e.g., water.

In various embodiments, the method of creating a fibre may allow continuous spooling of fine fibres (e.g., fibres having an average diameter of from about 0.05 to about 0.50 mm) through careful preparation of the viscosity of the second liquid composition (e.g., polyion solution), appropriate selection of tubing sizes, sufficient retardation of the dispensing rate of the first liquid composition (e.g., crosslinker or polyion solution) and second liquid composition (e.g., polyion solution) emerging from the first tube and second tube, respectively, and precise increment in the speed of rotation/rotation rate of the rotatable collector (e.g., cylinder).

In various embodiments, the viscosity of the second liquid composition (e.g., polyion solution) may fall in the range of from about 5 to about 70,000 cPs, or in the range of from about 5,000 to about 50,000 cPs. In various embodiments, the first and second tubes have an inner diameter falling in the range of from about 0.25 mm to about 4.00 mm, or in the range of from about 0.50 mm to about 1.50 mm. In various embodiments, the first and second dispensing rates of the respective first liquid composition (e.g., crosslinker or polyion solution) and second liquid composition (e.g., polyion solution) may fall in the range of from about 0.1 ml/min to about 0.8 ml/min, or in the range of from about 0.3 ml/min to about 0.5 ml/min. In various embodiments, the speed of rotation/rotation rate of the rotatable collector (e.g., cylinder) may fall in the range of from about 3 RPM to about 8 RPM, or in the range of from about 5 RPM to about 6 RPM.

Accordingly, in various embodiments of the method as disclosed herein, significant capillary action of the first liquid composition (e.g., crosslinker or polyion solution) from the first tube into the second tube of the second liquid composition (e.g., polyion solution) is promoted, leading to IPC happening upstream of the second tube outlet (i.e., opening outlet of the second tube). In various embodiments, a balance of outward flow of the second liquid composition (e.g., polyion solution) from the second tube and inward flow of the first liquid composition (e.g., crosslinker or polyion solution) may lead to a laminar flow within the second tube. In various embodiments, the dispensing force may be facilitated by the outward flow of the second liquid composition (e.g., polyion solution), which is governed by the second dispensing rate of the second liquid composition (e.g., polyion solution) (the “Push”). In various embodiments, the drawing force may be facilitated by the drawing of a distal part of the fibre that is adhered to the surface of the rotatable collector (the “Pull”). By regulating the “Push” and “Pull” (i.e., the dispensing force and the drawing force) with the presence of the first liquid composition (e.g., crosslinker or polyion solution) within the second tube, the fibre e.g., a fine IPC fiber is ejected from the interfacial polyelectrolyte interface. In various embodiments, the ejected fibre may be further crosslinked via bathing in the still suspended droplet comprising the first and second liquid compositions. In various embodiments therefore, the method may advantageously achieve continuous spooling of fine fibres.

### BRIEF DESCRIPTION OF FIGURES

FIG. 1A to FIG. 1G are schematic drawings illustrating a system for creating a fibre in an example embodiment.

FIG. 2A to FIG. 2E are schematic drawings illustrating a sequence of steps in a method creating a fibre in an example embodiment.

FIG. 3 is a schematic drawing illustrating a planar fibrous structure formed by an overlay of successive layers of drawn fibres in a plane that is perpendicular to a surface of a rotatable cylinder in an example embodiment.

FIG. 4 is a schematic drawing illustrating a fibrous structure built parallel to a surface of a rotatable cylinder by controlled movement of a fibre-drawing outlet in a direction parallel to the longitudinal axis of the rotatable cylinder in an example embodiment.

FIG. 5 is a schematic drawing illustrating fibrous structures formed using multiple fibre-drawing outlets fixed on a movable elongate support member that draw fibres simultaneously in an example embodiment.

FIG. 6A and FIG. 6B are photographs showing the configuration of a typical fibre-drawing outlet comprising a first tube having a first tube outlet and a second tube having a second tube outlet for dispensing solutions/suspensions I and II, placed against a guide member in an example embodiment.

FIG. 7A to FIG. 7D are photographs showing a sequence of steps during fibre drawing by a rotating drum in an example embodiment.

FIG. 8A to FIG. 8D are light microscope images of fibrous constructs obtained using a polyanion-polycation pair of alginate-chitosan (FIG. 8A, FIG. 8B) and a polyion-crosslinker pair of alginate-calcium chloride (FIG. 8C, FIG. 8D) in an example embodiment.

FIG. 9 is a photograph showing a series of fibre-drawing outlets fixed on a support member that is moved at a controlled rate in a direction parallel to the longitudinal/rotational axis of a rotatable cylinder in an example embodiment. Each fibre stream corresponds to one solution pair.

FIG. 10A and FIG. 10B are photographs showing drawing of fibre and build-up of a fibrous construct using the setup of Example 2, leading to differently coloured fibrous layers. FIG. 10A and FIG. 10B are successive photographs taken over time.

FIG. 11 is a photograph showing a fibre construct comprising differently coloured fibre layers, formed using a setup and method of Example 2.

FIG. 12 is a photograph showing the setup of Example 3 where thinner fibres are generated with a lower solution dispense rate of about 0.2 ml/min.

FIG. 13 is a photograph of a setup of Example 3, with the fibre-drawing outlet at a 10 o'clock position dispensing IPC fibre. One of 3 stirrer extensions is seen attached to a rotating cylinder to continuously stir a bath containing starch and red colouring.

FIG. 14 is a photograph showing fibrous constructs made using the setup of Example 3, incorporating a bath with red colouring.

FIG. 15 is a photograph showing a setup of Example 4, with a primary fibre-drawing outlet for solutions/suspensions I and II at a 10 o'clock position and an outlet for post draw dispensing at a 2 o'clock position.

FIG. 16 is a photograph showing a fibrous construct made from chitosan and calcium crosslinked alginate fibres, incorporating pea protein in an example embodiment.

FIG. 17A to FIG. 17C are a series of high-contrast time-lapse photos showing infiltration of a solution I dispensed from a first tube outlet into a second tube via capillary action in an example embodiment.

FIG. 18 is a graph showing fibre diameters of fibres produced using different process parameters in an example embodiment.

### DETAILED DESCRIPTION OF FIGURES

Example embodiments of the disclosure will be better understood and readily apparent to one of ordinary skill in the art from the following discussions and if applicable, in conjunction with the figures. It should be appreciated that other modifications related to structural, material, and chemical changes may be made without deviating from the scope of the invention. Example embodiments are not necessarily mutually exclusive as some may be combined with one or more embodiments to form new exemplary embodiments. The example embodiments should not be construed as limiting the scope of the disclosure.

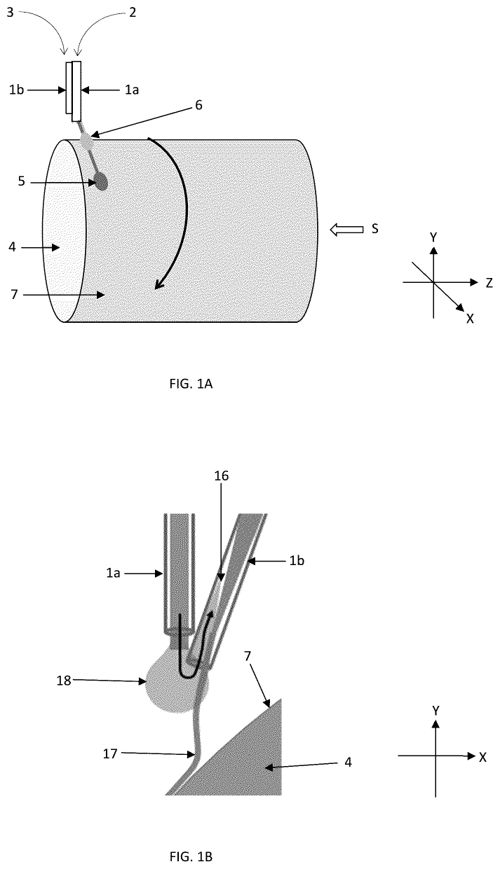

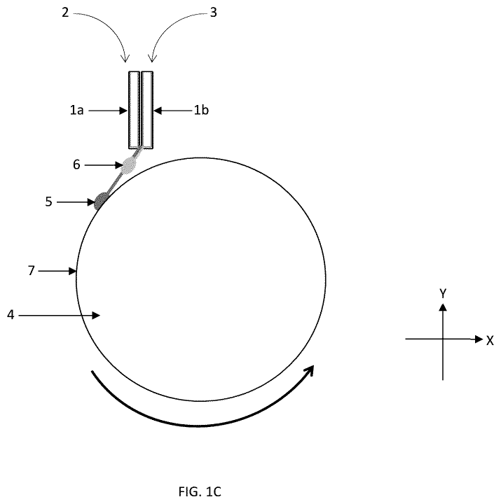

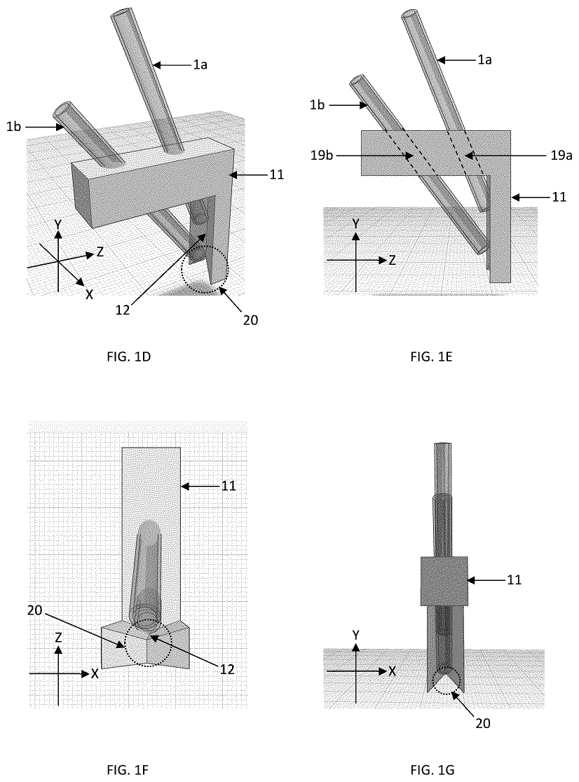

FIG. 1A is a perspective view schematic drawing of a system for creating an IPC fibre in an example embodiment. The system comprises a fibre-drawing outlet comprising a first tube (1a) having a first tube outlet for dispensing a first liquid composition, e.g., crosslinker solution (2), at a first dispensing rate; and a second tube (1b) having a second tube outlet for dispensing a second liquid composition, e.g., a polyion solution (3), at a second dispensing rate. The system further comprises a rotatable collector, e.g., rotatable cylinder (4), for applying a drawing force to draw and collect the fibre. The rotatable cylinder (4) is configured to rotate about its longitudinal axis that is aligned substantially parallel to a horizontal plane (i.e., X-Z plane).

FIG. 1B is a close-up schematic drawing of the first and second tubes (1a, 1b) when viewed from one end of the rotatable cylinder (4) in the example embodiment. The side view drawing of FIG. 1B illustrates the view taken from directional arrow(S) as indicated on FIG. 1A. FIG. 1B illustrates the first mechanism of fibre formation as disclosed herein. As shown in FIG. 1B, the first tube (1a) is positioned in proximity with respect to the second tube (1b) to allow the first liquid composition, e.g., crosslinker solution (2), dispensed from the first tube outlet to flow into the second tube outlet via capillary action (see arrow indicating direction of fluid movement) to form an interfacial polyelectrolyte complex (16) with the second liquid composition, e.g., a polyion solution (3), within the second tube (1b). The second tube (1b) is configured to facilitate a dispensing force provided by the second dispensing rate to eject a fibre (17) from the interfacial polyelectrolyte complex (16) and contact a target location on the surface (7) of the rotatable cylinder (4). The fibre (17) that is ejected may be further crosslinked via bathing in a still suspended droplet (18) of the crosslinker solution. The rotatable cylinder (4) is positioned relative to the first and second tubes (1a, 1b), such that the fibre (17) moves in a direction away from the outlets of the first and second tubes (1a, 1b) upon contacting the target location on the surface (7) of the rotatable cylinder (4), when the rotatable cylinder (4) is in rotation. The rotatable cylinder (4) is configured to facilitate a drawing force that allows the fibre (17) to continuously increase in length, by rotating in a direction to continuously draw the fibre (17) from the interfacial polyelectrolyte complex (16).

FIG. 1C is a side view schematic drawing of the system when viewed from one end of the rotatable cylinder (4) in the example embodiment. The side view drawing of FIG. 1C illustrates the view taken from directional arrow(S) as indicated on FIG. 1A. FIG. 1C illustrates the second mechanism of fibre formation as disclosed herein.

As shown in FIG. 1C, the first tube (1a) and second tube (1b) are positioned at an 11 o'clock position with respect to the circular cross section of the rotatable cylinder (4) configured to rotate in an anti-clockwise direction, at a distance of about 1.5 cm away from a surface (7) of the cylinder (4). Alternatively, the first and second tubes (1a, 1b) may be positioned at a 1 o'clock position with respect to the circular cross section of the rotatable cylinder (4) configured to rotate in a clockwise direction, at a distance of about 1.5 cm away from a surface (7) of the cylinder (4).

In the example embodiment, the first and second tubes (1a, 1b) may be positioned at a 9 to 12 o'clock position with respect to the cylinder cross section, with the rotatable cylinder rotating in an anti-clockwise direction. For example, the first and second tubes (1a, 1b) may be positioned at a 10 to 11 o'clock position with respect to the cylinder cross section, with the rotatable cylinder rotating in an anti-clockwise direction. Alternatively, the first and second tubes (1a, 1b) may alternatively be positioned at a 12 to 3 o'clock position with respect to the cylinder cross section, with the rotatable cylinder rotating in a clockwise direction. For example, the first and second tubes (1a, 1b) may be positioned at a 1 to 2 o'clock position with respect to the cylinder cross section, with the rotatable cylinder rotating in a clockwise direction.

In the example embodiment, the first and second tubes (1a, 1b) may be positioned at a distance of from about 0.5 cm to about 5 cm away from the surface (7) of the rotatable cylinder (4). For example, the first and second tubes (1a, 1b) may be positioned at a distance of from about 1 cm to about 3 cm away from the surface (7) of the rotatable cylinder (4).

As shown in FIG. 1C, the rotating cylinder (4) provides a continuous moving surface (7) that attaches successive droplets (5, 6) from which fibre is drawn by an IPC mechanism, to form a continuous fibre around the longitudinal axis of the cylinder (4). The first tube (1a) is positioned in proximity with respect to the second tube (1b) to allow the crosslinker solution (2) dispensed from the first tube outlet (1a) and the polyion solution (3) dispensed from the second tube outlet (1b) to contact each other and to form a droplet, e.g., the initial droplet (5). The initial droplet (5) comprises the crosslinker solution (2) and the polyion solution (3) separated by an interfacial polyelectrolyte complex (16) within the initial droplet (5). The initial droplet (5) is allowed to depart from a suspended position between the outlets of the first and second tubes (1a, 1b) and descend under the influence of gravity to contact and attach to the surface (7) of the rotatable cylinder (4). The initial droplet (5) that is attached to the surface (7) of the rotatable cylinder (4) is connected to the outlets of the first and second tubes (1a, 1b) via a fibre drawn from the interfacial polyelectrolyte complex within the initial droplet (5). Rotation of the rotatable cylinder (4) in an anti-clockwise direction applies a drawing force to continuously draw the fibre from the interfacial polyelectrolyte complex within the initial droplet (5) that is attached on the surface (7) of the rotatable cylinder (4). A subsequent droplet (6) is formed between the outlets of the first and second tubes (1a, 1b) and allowed to roll along the fibre formed by the initial droplet (5) and attach to the surface (7) of the rotatable cylinder (4) when in rotation. Fibre is drawn from the interfacial polyelectrolyte complex within the subsequent droplet (6) that is attached on the surface (7) of the rotatable cylinder (4).

A person skilled in the art would understand that the first and second mechanisms of fibre formation can be carried out within the same system for creating the fibre.

In the example embodiment, the system may further comprise a guide member (11) for guiding flow of liquid in a designated direction. FIG. 1D is a perspective view drawing of a guide member (11) in one example embodiment. FIG. 1E is a side view drawing of the guide member (11) in the example embodiment. FIG. 1F is a bottom view drawing of the guide member (11) in the example embodiment. FIG. 1G is a front view drawing of the guide member (11) in the example embodiment. As shown in FIG. 1D to FIG. 1G, the guide member (11) comprises a first receptacle (19a) for receiving the first tube (1a) and a second receptacle (19b) for receiving the second tube (1b), said first and second receptacles (19a, 19b) orientated such that the first and second tubes (1a, 1b) are in proximity to, and at a desired angle with respect to each other, when inserted into the receptacles (19a, 19b). The guide member (11) further comprises a groove (12) formed on one of its surfaces and positioned in proximity to the outlets of the first and second tubes (1a, 1b) when the tubes (1a, 1b) are inserted into the receptacles (19a, 19b), to guide the first and second liquid compositions dispensed therefrom to flow towards the target location on the surface of the rotatable cylinder (4). The guide member (11) further comprises a groove tip, e.g., V-shaped groove tip (20) disposed at one end of the groove (12) for focusing the first liquid composition, e.g., crosslinker solution (2) and second liquid composition, e.g., polyion solution (3) prior to leaving the guide member (11). As shown in FIG. 1D, the V-shaped groove tip is configured such that a resulting droplet comprising the crosslinker solution (2) and polyion solution (3) is allowed to focus/accumulate at the apex/vertex of the V-shaped groove tip (20) prior to leaving the guide member (11).

In the example embodiment, the system may be used to implement a method of fibre production and assembly on a rotating cylinder. Advantageously, the system and associated method may enable continuous fine fiber spooling on the drum/cylinder surface.

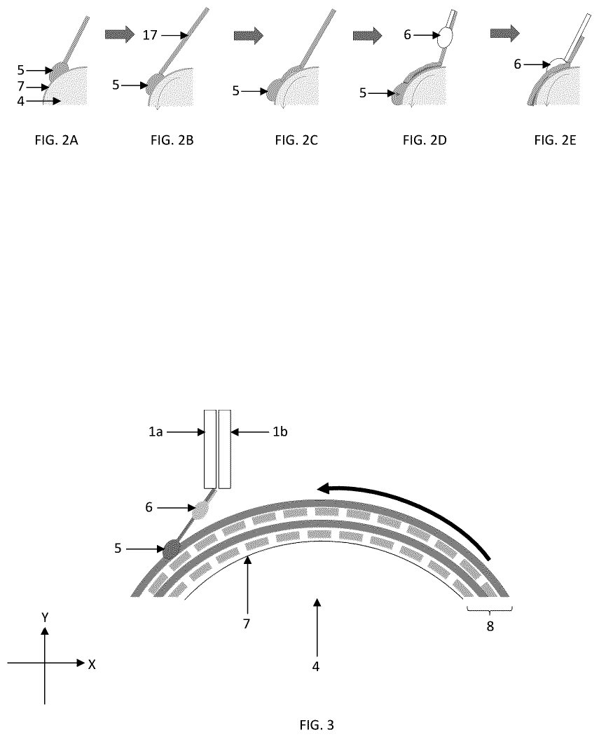

FIG. 2A to FIG. 2E are schematic drawings illustrating a sequence of steps in a method of creating a fibre (17) in an example embodiment. The sequence of steps illustrated in FIG. 2A to FIG. 2E are implemented using the system as described in FIG. 1A to FIG. 1C.

In FIG. 2A, an initial droplet (5) comprising a polyion-crosslinker pair or polycation-polyanion pair and other food components, is dispensed and attached on a surface (7) of a rotatable cylinder (4).

In FIG. 2B, a fibre (17) is drawn from the initial droplet (5) by rotation of the rotatable cylinder (4) in an anti-clockwise direction. Rotation of the rotatable cylinder (4) applies a drawing force for drawing the fibre (17) by allowing the fibre (17) to move in a direction away from the outlets of the first and second tubes (1a, 1b) upon contacting the target location on the surface (7) of the rotatable cylinder (4) when the rotatable cylinder (4) is in rotation.

In FIG. 2C, the fibre (17) is laid down on the surface (7) of the cylinder (4) by rotation of the cylinder (4). Rotation of the rotatable cylinder (4) allows the fibre to be continuously increasing in length.

In FIG. 2D, a subsequent newly-formed droplet (6) is allowed to roll along the fibre (17).

In FIG. 2E, the subsequent newly-formed droplet (6) is allowed to attach to the surface (7) of the rotatable cylinder (4).

In the example embodiment, the sequence of steps illustrated in FIG. 2A to FIG. 2E is repeated, such that fibres from subsequent droplets are drawn and laid down by rotation of the cylinder (4). Overlapping of fibres arising from each droplet occurs, resulting in a continuous fibre layer.

In the example embodiment, to achieve continuous laying down of fibre (17) and a continuous fibre layer on the cylinder (4), the dispensing rate of the droplet is coordinated with the rotational speed of the rotatable cylinder (4) such that a second droplet attaches to the cylinder (4) before fibre (17) arising from a first droplet breaks. For instance, a continuous calcium alginate fibre layer can be achieved with a dispensing rate of 0.5 mL/min of the first and second tubes (1a, 1b) and a rotational speed of 1.5 RPM of the rotatable cylinder (4), for a rotatable cylinder (4) having a diameter of about 100 mm (see Example 1 below).

In the example embodiment, it will be appreciated that the production of a continuous fibre layer or fibrous construct may depend on the dispensing rate of the first and second liquid compositions (2, 3) matched with the rotational speed of the rotatable cylinder (4), as well as the concentration and type of liquid compositions used in the process of fibre production. To increase the rate of fibrous construct formation, the rotational speed of the cylinder (4) can be increased, provided that the dispensing rate of the first and second liquid compositions (2, 3), e.g., polyion and the crosslinking agent/other polyion also be increased accordingly, in a coordinated fashion. When the rate at which the polyion and crosslinker are dispensed becomes fast enough, the discrete droplets (5, 6) may merge into a continuous fibre stream.

FIG. 3 is a side view schematic drawing of the system showing a vertical build-up of fibres in the example embodiment. As shown in FIG. 3, overlay of successive layers of fibre (17) in a plane perpendicular to the surface of the cylinder (7) may result in a planar fibrous structure, termed vertical build up (8). This can be achieved by maintaining the first and second tubes (1a, 1b) in a fixed position relative to the longitudinal axis of the rotatable cylinder (4), such that newly drawn portions of the fibre (17) are overlaid on top of previously drawn portions of the fibre (17) collected on the rotatable cylinder (4).

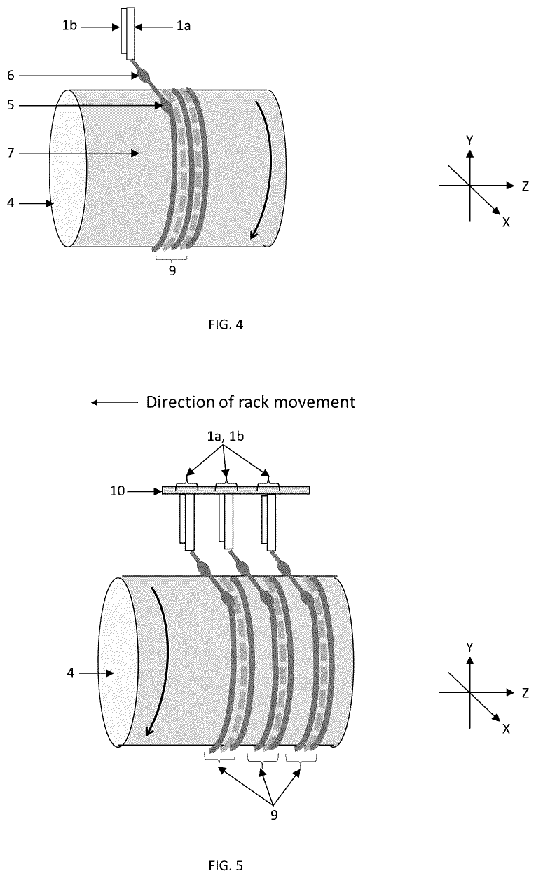

FIG. 4 is a perspective view drawing of the system showing a horizontal build-up of fibres in the example embodiment. As shown in FIG. 4, the outlets of the first and second tubes (1a, 1b) can be moved in a controlled rate relative to the rotating cylinder (4), in a direction parallel to its longitudinal axis, which allows a fibrous structure to be built parallel to the surface (7) of the cylinder (4), termed horizontal build up (9).

It will be appreciated that a combination of vertical and horizontal build up results in the formation of a three-dimensional fibrous structure.

FIG. 5 is a perspective view drawing of the system showing fibrous structures formed using multiple first and second tubes (1a, 1b) fixed on a movable elongate support member (10) that draw fibres simultaneously in the example embodiment. A plurality of first and second tubes (1a, 1b) can be positioned adjacent to each other, fixed in position by the elongate support member (10). For example, the elongate support member (10) may be a rack containing a plurality of holes to accommodate the plurality of first and second tubes (1a, 1b). The rack can be made movable at a controlled rate using a linear motor, fibres drawn from each of the outlets simultaneously generating fibrous constructs by horizontal build up (9). Subsequent movement of the rack in the opposite direction with drawing of fibre results in vertical build up, and hence three-dimensional structures for all the fibrous constructs. When the fibrous constructs are made to come into contact or overlap, a larger, single fibrous construct is produced.

In making the fibrous constructs, rotation of the cylinder is also advantageous as the excess solution is allowed to drip off the cylinder surface. Accumulation of the excess solution would otherwise lead to swelling of the fibres, leading to poor mechanical properties of the construct.

### EXAMPLES

### Example 1

In the following example, it is shown how the method of creating a fibre as disclosed herein was used for fibre assembly to make a fibrous construct. In this example, a rotatable collector in the form of a rotatable cylindrical support was used.

Two solutions (I and II), comprising a crosslinker and a polyion, or two oppositely charged polyions, were separately prepared. Combination of the two solutions resulted in formation of a fibre.

Solution I: 1% (w/v) calcium chloride solution, OR 1% (w/v) chitosan solution

For 10 mL of 1% (w/v) CaCl₂) (aq) solution, 0.1 g of calcium chloride (Redman) was weighed and added to a 50 mL centrifuge tube, 10 ml of water was added, and the whole vortexed to completely dissolve the calcium chloride.

For 10 mL of 1% (w/v) chitosan solution, 0.1 g of chitosan (from Aspergillus Niger, Glentham Life Sciences) was weighed and added to a 50 mL centrifuge tube, 10 mL of 0.15 M acetic acid was added, and the whole vortexed to completely dissolve the chitosan.

Solution II: 1% (w/v) Sodium Alginate

For 10 mL of solution, 0.1 g of sodium alginate (Redman) was weighed and added to a 50 mL centrifuge tube, 10 mL of deionized water was added, and the whole vortexed to completely dissolve the alginate, giving a 1% (w/v) sodium alginate (aq) solution.

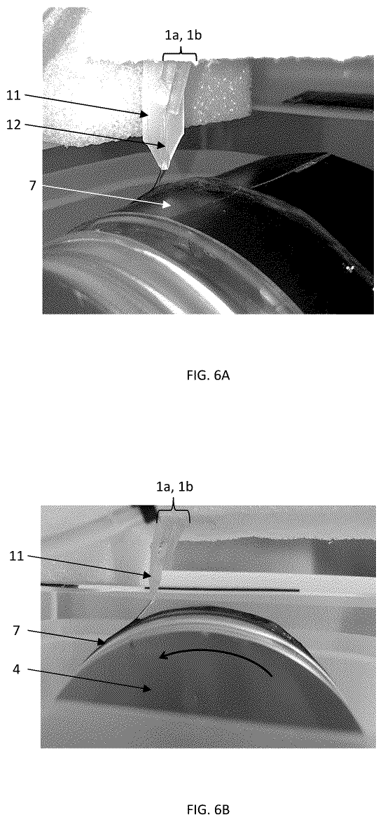

Referring to FIG. 6A, two 50 mL syringes (not shown) were filled with 10 mL each of Solutions I and II, respectively. The syringes containing Solutions I and II were affixed onto a syringe pump (not shown) and connected to tubings with an inner diameter of about 2.5 mm, before being connected to a first tube (1a) having a first tube outlet and a second tube (1b) having a second tube outlet, respectively, said first and second tubes having an inner diameter of about 1 mm. The outlets of the first and second tubes (1a, 1b) were placed against a guide member (11). The guide member (11) comprised a flat piece of plastic with a groove (12) formed on its middle portion. The groove (12) was aligned between (i.e., in the middle of) the two tubes (1a, 1b) and was configured to guide a direction of flow of the solutions as shown in FIG. 6A, thus facilitating fibre formation.

Referring to FIG. 6B, the outlets of the first and second tubes (1a, 1b) were positioned above a rotatable cylinder/drum (4) for collecting the fibre. In particular, the outlets were fixed in place at about the 11 o'clock position with respect to the rotatable cylinder (4), at a distance of about 2 cm from a surface (7) of the rotatable cylinder (4). In the current example, the rotatable cylinder (4) is in the form of a drum with a diameter of about 100 mm. In other words, when viewed from the circular cross section at one end of the rotatable cylinder (4) as shown in FIG. 6B, the fibre that resulted from the combination of the two solutions was configured to attach to a target location corresponding to about the 11 o'clock position on the surface (7) of the rotatable cylinder (4).

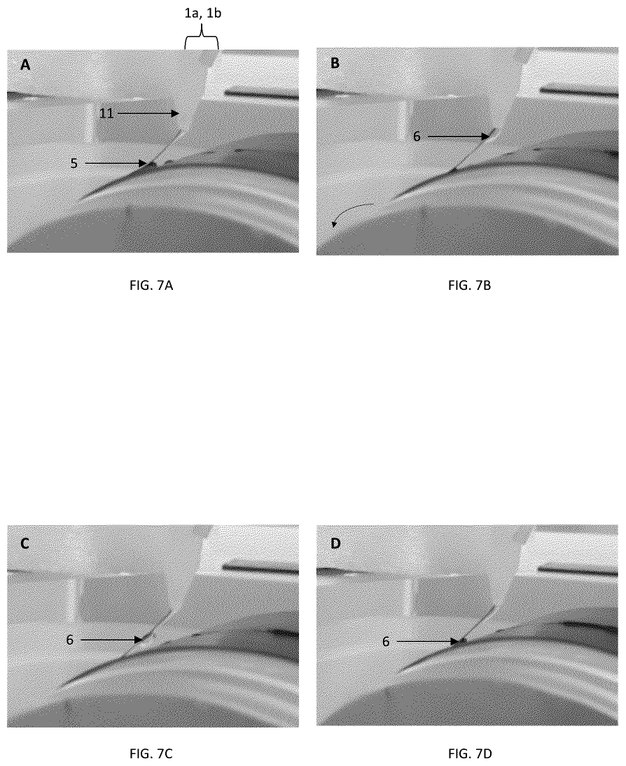

The syringe pump was operated at a rate of about 0.5 mL/min and the cylinder (4) was rotated in an anticlockwise direction (as indicated by the arrow on the cylinder (4) in FIG. 6B) at a rate of 1.5 revolutions per min (RPM) using a motor. Upon contact of the two respective solutions dispensed from the outlets of the first and second tubes (1a, 1b), a first resultant partially crosslinked gel droplet (5) descended by gravity (i.e., moved along a trajectory attributable to the force of gravity acting on the gel droplet (5)), and settled on the surface (7) of the rotating cylinder (4), drawing a fibre between the cylinder surface (7) and outlets of the first and second tubes (1a, 1b) in the process as shown in FIG. 7A to FIG. 7D.

Referring to FIG. 7A, the fibre was continuously drawn by an IPC process due to the rotation of the rotatable cylinder (4), which progressively increased the distance between the droplet (5) and the outlets of the first and second tubes (1a, 1b). At the same time, the resultant fibre was deposited on the surface (7) of the rotatable cylinder (4) to form a first fibre. Referring to FIG. 7B to FIG. 7D, as the two solutions/suspensions continued to be dispensed, a second resultant droplet (6) was formed and descended along the long axis of the first fibre and landed on the surface (7) of the rotating cylinder (4), which eventually resulted in the drawing of a second fibre, which was laid along the long axis of the first fibre in a staggered manner. This staggered laying of fibres was repeated for subsequent droplets that formed upon continued dispensing of the two solutions. One complete round of the rotating cylinder (4) led to the formation of the first fibre layer. With each subsequent rotation of the cylinder (4), layers of fibres were successively overlayed on the first fibre layer, thus increasing thickness of the fibre construct.

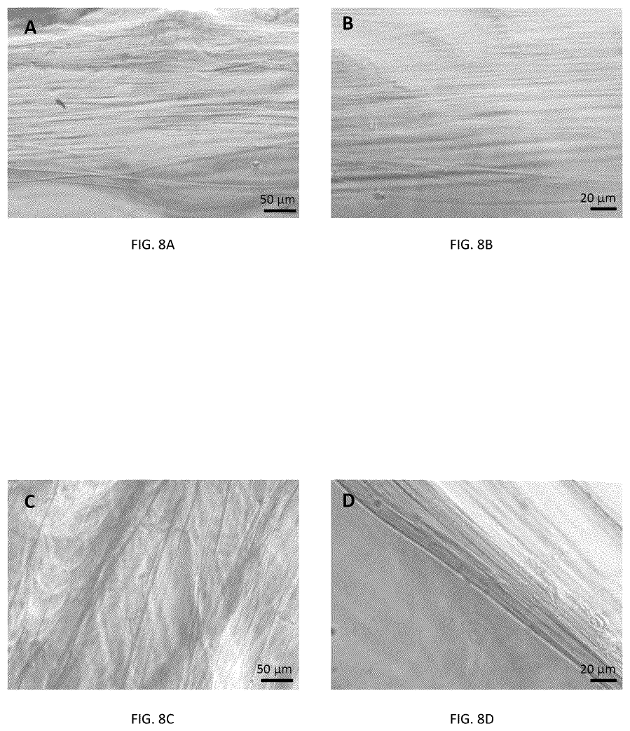

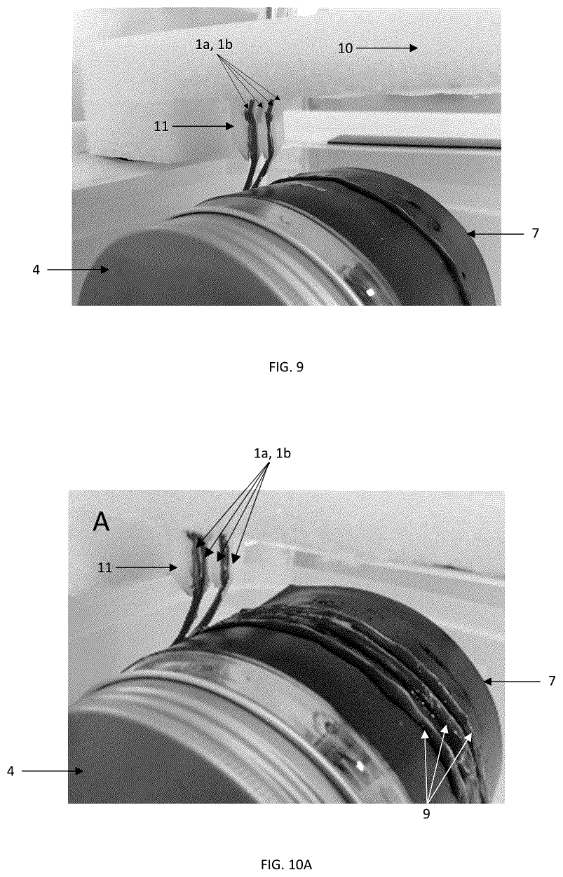

After the volume of solutions in the syringes had been completely dispensed, the pump was stopped, and the fibre construct was removed from the rotatable cylinder (4). FIG. 8A to FIG. 8D show light microscope images of the fibrous construct obtained using polyion-crosslinker pairs of alginate-calcium and polyion-polyion pairs of alginate-chitosan using the method of this example. The presence of micron sized nuclear fibres supports a process of fibre formation by an IPC mechanism.

In the following examples, various food components have been incorporated into the solutions, and fibres have been drawn and assembled on a rotatable cylinder in a manner similar to that described in Example 1.

### Example 2

In the following example, it is shown how the method of creating a fibre as disclosed herein was used for fibre assembly to make a patterned plant-based meat analogue comprising different components. In this example, a rotatable collector in the form of a rotatable cylindrical support was used.

Two solutions (I and II), comprising a crosslinker and a polyion, were separately prepared. Combination of the two solutions resulted in formation of a fibre.

Solution I: 1% (w/v) calcium chloride solution

### Solution/Suspension II:

The following suspensions corresponding to three coloured fibre layers were prepared:

Red: 1% (w/v) sodium alginate containing 7.5% (w/v) pea protein isolate

For 10 mL of solution/suspension, 0.75 g of pea protein isolate (VitEssence) was added to the sodium alginate solution and dispersed using a vortex and/or stirring with a spatula until a homogenous suspension was obtained. 50 mg of cherry red food colouring powder was then added in the prepared suspension and dispersed as before.

Yellow: 1% (w/v) sodium alginate containing 5% (w/v) lecithin and 5% (v/v) canola oil

For 10 mL of solution/suspension, 0.5 g of soy lecithin (Redman) and 500 μl of canola oil (LioFood) was added to the prepared sodium alginate solution and dispersed using a vortex and/or stirring with a spatula until a homogenous suspension was obtained. 20 μl of egg yellow food colouring (Redman) was then added into the prepared emulsion and dispersed as before.

White: 1% (w/v) sodium alginate containing 7.5% (w/v) corn flour

For 10 mL of solution/suspension, 0.75 g of corn flour (Pagoda brand) was added to the sodium alginate solution and dispersed using a vortex and/or stirring with a spatula until a homogenous suspension was obtained.

Four pairs of the respective solutions/suspensions I and II were loaded into corresponding pairs of 10 mL syringes. Each pair of syringes containing Solution I and Solution/suspension II were affixed onto a syringe pump (not shown) and connected to tubings with an inner diameter of about 2.5 mm, before being connected to a first tube (1a) having a first tube outlet and a second tube (1b) having a second tube outlet, respectively, said first and second tubes having an inner diameter of about 1 mm. The outlet for each syringe (solution) pair comprised the ends of the first and second tubes (1a, 1b) placed against a guide member (11) with individual grooves (12), which guided the direction of flow of the solutions. The outlets of the first and second tubes (1a, 1b) were fixed onto a movable support member (10) and positioned at the 10 o'clock position with respect to the long axis of a rotatable cylinder (4), at a distance of 2 cm from the surface (7) of the rotatable cylinder (4), as shown in FIG. 9. In this case, the rotatable cylinder (4) is a drum having a diameter of about 100 mm. The movable support member (10) can be made to move in a direction parallel to the axis of rotation of the rotatable cylinder (4) using a linear motor.

The syringe pump was operated at a rate of about 0.5 mL/min and the rotatable cylinder (4) was rotated in an anticlockwise direction at a rate of about 1 RPM using a motor. The movable support member (10) was configured to move the outlets of the first and second tubes (1a, 1b) along the axis of rotation of the rotatable cylinder (4) linearly at a rate of about 0.4 cm/min in a first direction, and further configured to reverse and move in a second opposite direction once the outlets of the first and second tubes (1a, 1b) reach either end of the rotatable cylinder (4). Drawing of fibre and build-up of the fibrous construct proceeded in a similar manner as described in Example 1, except that the different fibre streams employed in the current example led to differently coloured fibrous layers that could be combined to form a 3D patterned fibrous construct with horizontal buildup (9) as shown in FIG. 10A and FIG. 10B.

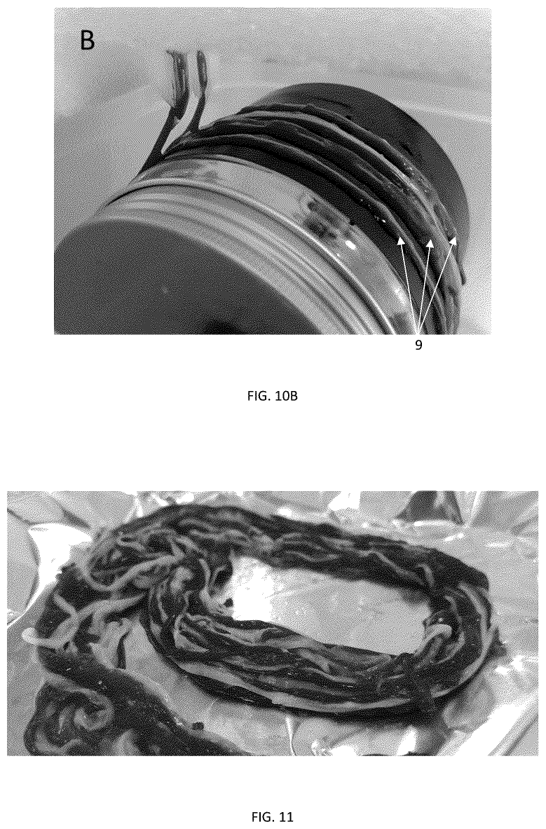

After the volume of solutions/suspensions in the syringes had been completely dispensed, the pump was stopped. The fibrous construct was removed from the cylinder, laid flat on a piece of aluminium foil, and heated on a hotplate at about 80° C. for about 20 minutes. The fibrous construct was then rinsed thrice in water to remove excess calcium chloride. The appearance of the resulting construct is shown in FIG. 11.

### Example 3

In the following example, it is shown how immersion of the rotating cylinder in a bath containing other ingredients, nutrients and/or supplements during the process of making fibrous constructs can be used to modify the fibrous constructs.

Solution I: 1% (w/v) calcium chloride solution

Solution/suspension II: 1% (w/v) sodium alginate containing 12.5% (w/v) pea protein isolate and 2.5% (w/v) coconut flour, turmeric, cumin and salt.

For 20 mL of solution/suspension, 2.5 g of pea protein isolate (VitEssence) and 0.5 g of coconut flour (Pagoda) was added to the sodium alginate solution and dispersed using a vortex and/or stirring with a spatula until a homogenous suspension was obtained. 50 mg of turmeric (Redman), 50 mg of cumin (Redman) and 50 mg of sea salt (Deltasal) were added and the suspension was dispersed again.

Solution III (bath): 5% (w/v) sweet potato starch, red colouring

For 800 mL of solution/suspension, 40 g of sweet potato starch (Sunflower brand) and 1 g of cherry red colouring powder (Redman) was added to water and dispersed by stirring.

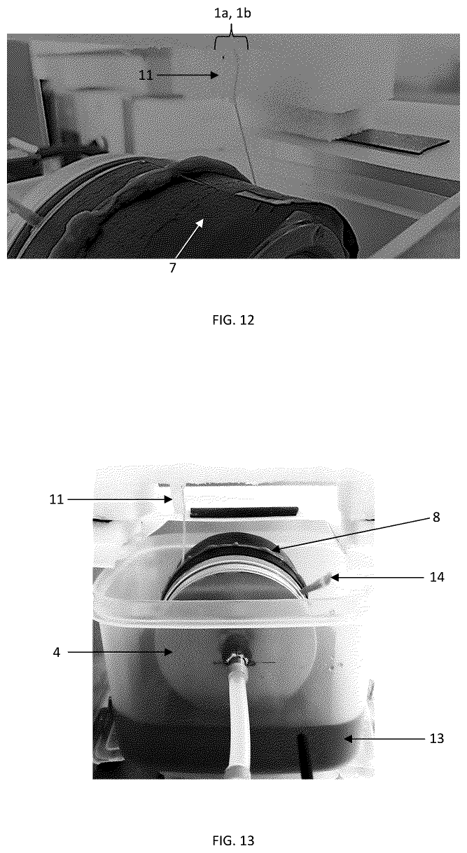

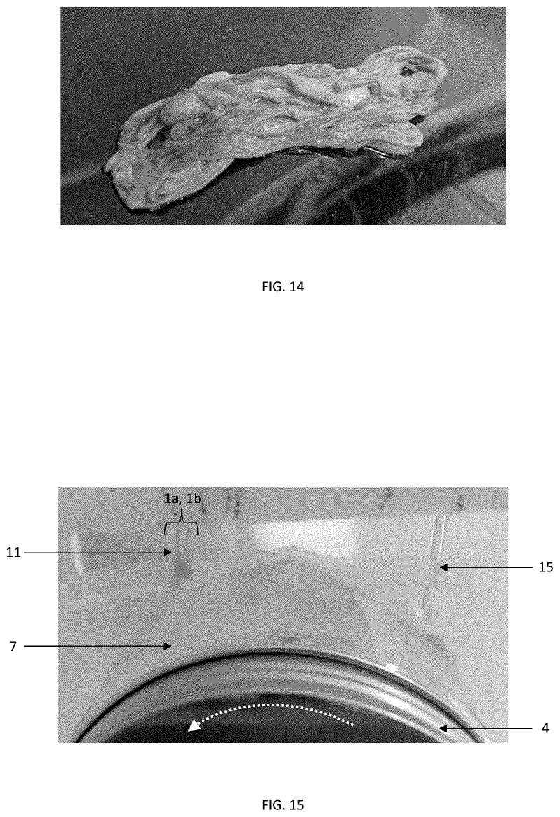

Two 10 mL syringes were filled with 10 mL each of Solutions/suspensions I and II, respectively. The syringes containing Solution I and Solution/suspension II were affixed onto a syringe pump (not shown) and connected to tubings with an inner diameter of about 2.5 mm, before being connected to a first tube (1a) having a first tube outlet and a second tube (1b) having a second tube outlet, respectively, said first and second tubes having an inner diameter of about 1 mm. The outlets of the first and second tubes (1a, 1b) were placed against a guide member (11), which contained a groove through the middle (12) that guided the direction of flow of the solutions as before. The outlets of the first and second tubes (1a, 1b) were fixed in place at the 10 o'clock position with respect to a rotatable cylinder (4), as illustrated in FIG. 12, at a distance of about 4.5 cm from a surface (7) of the cylinder (4). A lower dispense rate is used to generate thinner IPC fibres. In the current example, the rotatable cylinder (4) is in the form of a drum with a diameter of about 100 mm, with stirrers (14) attached to its surface to continuously mix the starch-based colouring bath (13) as shown in FIG. 13. The syringe pump was operated at a rate of about 0.2 mL/min and the rotatable cylinder (4) was rotated in an anti-clockwise direction at a rate of 1.5 RPM using a motor. The bath (13) imbues the forming construct with starch and red colouring as shown in FIG. 14. To remove excess solution from the fibrous construct, the rotatable cylinder (4) can be allowed to rotate for several minutes prior to collection of the construct.

### Example 4

In the following example, it is shown how post-drawing dispensing of a solution containing a crosslinker, other ingredients, supplements and/or nutrients can be carried out to modify the fibre/fibrous construct on the rotating cylinder.

Solution I: 0.5% (w/v) calcium chloride solution

Solution/suspension II: 1% (w/v) sodium alginate containing 7.5% (w/v) pea protein isolate and 7.5% (w/v) corn flour

For 10 mL of solution/suspension, 0.75 g of pea protein isolate (VitEssence) and 0.75 g of corn flour (Pagoda) were added to the sodium alginate solution and dispersed using a vortex and/or stirring with a spatula until a homogenous suspension was obtained.

Solution III (post-drawing dispensing outlet): 0.5% (w/v) calcium chloride solution

Two 10 mL syringes were filled with 10 mL each of solutions/suspensions I and II, respectively. The syringes containing Solution I and Solution/suspension II were affixed onto a syringe pump (not shown) and connected to tubings with an inner diameter of about 2.5 mm, before being connected to a first tube (1a) having a first tube outlet and a second tube (1b) having a second tube outlet, respectively, said first and second tubes having an inner diameter of about 1 mm. The outlets of the first and second tubes (1a, 1b) were placed against a guide member (11), composed of a conical polypropylene piece. The outlets of the first and second tubes (1a, 1b) were fixed in place at the 10 o'clock position with respect to a rotatable cylinder (4), at a distance of about 2 cm from a surface (7) of the cylinder (4). For post-drawing dispensing, a third 50 ml syringe was filled with solution III, affixed onto a syringe pump and connected to a third tube (15) having a third tube outlet, said third tube (15) having an inner diameter of about 1 mm. In the current example, the outlet of the third tube (15) was fixed at the 2 o'clock position with respect to the same rotatable cylinder (4) as shown in FIG. 15. The syringe pump was operated at a rate of about 0.5 mL/min and the rotatable cylinder (4) was rotated in an anti-clockwise direction at a rate of about 1.5 RPM using a motor.

In a variation of this example, two post-drawing dispensing outlets may be used to dispense two additional components separately, which may optionally react with each other while modifying the fibrous construct on the rotatable cylinder (4). For example, the two post-drawing dispensing outlets may be two outlets dispensing alginate and calcium, respectively. Deposition of alginate on the fibrous construct followed by crosslinking with calcium chloride may help to bind the fibres and enhance the mechanical properties of the construct.

### Example 5

In the following example, it is shown how the method of creating a fibre as disclosed herein was used for fibre assembly to make a plant-based meat analogue using a pair of oppositely charged polyions. In this example, a rotatable collector in the form of a rotatable cylindrical support was used.

Solution I: 2% (w/v) chitosan solution in 0.75 M acetic acid

For 10 mL of solution, 0.2 g of chitosan (from Aspergillus Niger, Glentham Life Sciences) was added to 10 mL of 0.75 M acetic acid and dispersed using a vortex and/or stirring with a spatula until a clear solution was obtained.

Solution/suspension II: 1% (w/v) sodium alginate containing 10% (w/v) pea protein isolate and 0.1% (w/v) calcium carbonate

For 10 mL of solution/suspension, 1 g of pea protein isolate (VitEssence) was added to the sodium alginate solution and dispersed using a vortex and/or stirring with a spatula until a homogenous suspension was obtained. 0.01 g of calcium carbonate (Merck) was then added and vortexed/stirred till it was homogenously dispersed.

Two 10 mL syringes were filled with 10 mL each of solutions/suspensions I and II, respectively. The syringes containing Solution I and Solution/suspension II were affixed onto a syringe pump (not shown) and connected to tubings with an inner diameter of about 2.5 mm, before being connected to a first tube (1a) having a first tube outlet and a second tube (1b) having a second tube outlet, respectively, said first and second tubes having an inner diameter of about 1 mm. The outlets of the first and second tubes (1a, 1b) were placed against a guide member (11), which contained a groove through the middle (12) that guided the direction of flow of the solutions as before. The outlets of the first and second tubes (1a, 1b) were fixed in place at the 10 o'clock position with respect to a rotatable cylinder (4), at a distance of about 1 cm from a surface (7) of the rotatable cylinder (4). The syringe pump was operated at a rate of about 0.5 mL/min and the rotatable cylinder (4) was rotated in an anticlockwise direction at a rate of about 1.5 RPM using a motor.

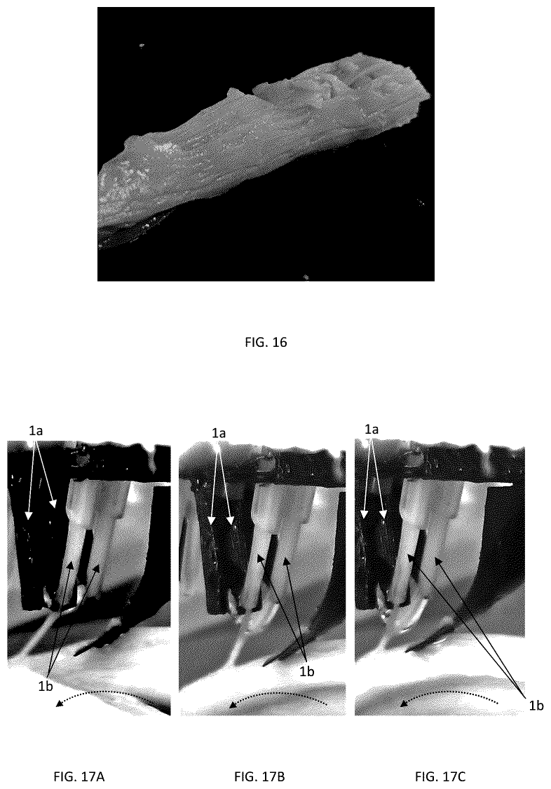

During fibre drawing, contact of calcium carbonate in Solution II with the acetic acid of Solution I led to release of calcium, which crosslinked the freshly formed chitosan-alginate fibres, thus increasing their mechanical properties. This led to a coherent fibrous construct with clearly defined fibres as shown in FIG. 16.

### Example 6

In the following example, it is shown how fine fibres can be spooled continuously by regulation of the dispense parameters.

Solution I (crosslinker solution): 0.5% (w/v) calcium chloride solution

Solution/suspension II (polyion solution): 0.66% (w/v) sodium alginate containing 15% (w/v) pea protein isolate, 10% (v/v) canola oil and 2% (w/v) gum arabic.

For 10 mL of solution/suspension, 1.5 g of pea protein isolate (VitEssence), 1 mL canola oil and 0.2 g gum arabic were added to the sodium alginate solution and dispersed using a vortex and/or stirring with a spatula until a homogenous suspension was obtained. The resulting mixture has a viscosity of approximately 30,000 cPs.

Two 10 mL syringes were filled with 10 mL each of solutions/suspensions I and II, respectively. The syringes containing Solution I and Solution/suspension II were affixed onto a syringe pump and connected to a first tube (1a) having a first tube outlet and a second tube (1b) having a second tube outlet, respectively, said tubes having an inner diameter of about 1 mm. The tubings were arranged as before, but with the first tube (1a) placed further up, i.e., at a higher position relative to the second tube (1b). The tubing pairs were fixed in place at the 10 o'clock position with respect to a rotatable cylinder (4), at a distance of about 2 cm from a surface (7) of the cylinder (4). As shown in FIG. 17A to FIG. 17C, two pairs of adjacent tubing pairs are shown. The solution/suspensions were dispensed at a rate of about 0.3 mL/min and the rotatable cylinder (4) was rotated in an anticlockwise direction at a rate of about 5.5 RPM using a motor.

During fibre drawing, it was observed that solution I moved into the second tube (1b) via capillary action (see FIG. 17A to FIG. 17C). It can be seen that fine fibre formation has occurred while still within tubing (3) itself.

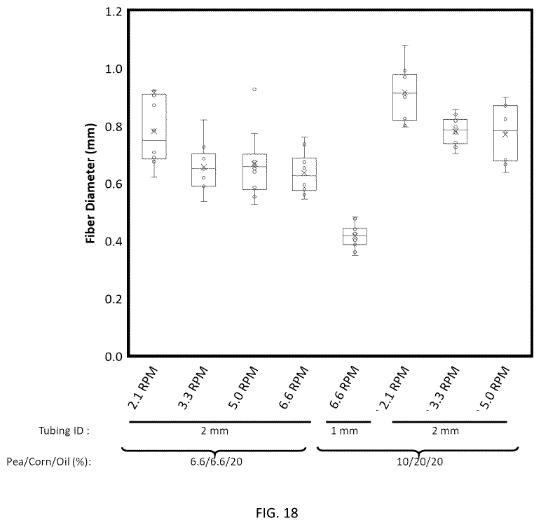

This example demonstrates that finely tuned fibre drawing parameters may lead to continuous spooling of fine fibres around the surface (7) of the rotatable cylinder (4). A plot of fibre diameter for different process parameters is shown in FIG. 18. In essence, fibre diameters can be tuned by the judicious choice of equipment (cylinder rotational speed) and formulation (ingredient loading) parameters.

### Applications

In the described example embodiments, the system and method of creating a fibre may advantageously achieve continuous spooling of fine fibres (e.g., fibres having an average diameter falling in the range of from about 0.05 mm to about 0.50 mm). In the described example embodiments, the system and method may be capable of producing a continuous length of fibres.

In the described example embodiments, the system and method may be applied in the production of meat substitutes/analogues. Advantageously, the inherent characteristics of IPC-drawn fibres, such as being comprised of finer nuclear fibres, allow it to approximate the microstructure of muscle and make it suitable for fabrication of meat analogues via encapsulation of proteins and other food components. Advantageously, the system and method of creating a fibre may be performed at ambient temperature and pressure, thereby facilitating incorporation and maintaining nutritional value of ingredients, e.g., bioactive ingredients that are sensitive to temperature and pressure. Even more advantageously, the system and method of creating a fibre may advantageously provide a scalable and more efficient approach to make fibrous meat-like constructs.

It will be appreciated by a person skilled in the art that other variations and/or modifications may be made to the embodiments disclosed herein without departing from the spirit or scope of the disclosure as broadly described. For example, in the description herein, features of different exemplary embodiments may be mixed, combined, interchanged, incorporated, adopted, modified, included etc. or the like across different exemplary embodiments. The present embodiments are, therefore, to be considered in all respects to be illustrative and not restrictive.

1. A system for creating a fibre, the system comprising,
a first tube having a first tube outlet for dispensing a first liquid composition at a first dispensing rate;
a second tube having a second tube outlet for dispensing a second liquid composition at a second dispensing rate; and
a rotatable collector for applying a drawing force to draw and collect the fibre, said rotatable collector being configured to rotate about its longitudinal axis that is aligned substantially parallel to a horizontal plane;
wherein the first tube is positioned in proximity with respect to the second tube to allow the first liquid composition from the first tube outlet and the second liquid composition from the second tube outlet to form an interfacial polyelectrolyte complex where a fibre is to be drawn therefrom.

2. The system according to claim 1, wherein the first tube is positioned in proximity with respect to the second tube to:
allow the first liquid composition dispensed from the first tube outlet to flow into the second tube outlet via capillary action to form the interfacial polyelectrolyte complex with the second liquid composition within the second tube, and where the second tube is configured to facilitate a dispensing force provided by the second dispensing rate to eject the fibre from the interfacial polyelectrolyte complex and contact a target location on a surface of the rotatable collector; and/or
allow the first liquid composition dispensed from the first tube outlet and the second liquid composition dispensed from the second tube outlet to form a droplet, said droplet comprising the first and second liquid compositions separated by the interfacial polyelectrolyte complex within the droplet, and where the fibre is drawn from the interfacial polyelectrolyte complex within the droplet when the droplet travels and contacts with a target location on a surface of the rotatable collector.

3. The system according to claim 1, wherein the rotatable collector is positioned relative to the first and second tubes, such that the fibre moves in a direction away from the outlets of the first and second tubes upon contacting the target location on the surface of the rotatable collector when the rotatable collector is in rotation.

4. The system according to claim 1, wherein the rotatable collector is configured to facilitate a drawing force that allows the fibre to continuously increase in length, by rotating in a direction to continuously draw the fibre from the interfacial polyelectrolyte complex.

5. The system according to claim 1, wherein the first and second tube outlets are positioned at a distance falling in the range of 0.5 cm to 5 cm away from the surface of the rotatable collector;
optionally wherein the first and second tubes have an inner diameter falling in the range of from 0.25 mm to 4 mm;
optionally wherein the rotatable collector is configured to rotate about its longitudinal axis at a rotational speed falling in the range of from 1.5 RPM to 8 RPM; and
optionally wherein the first and second dispensing rate fall in the range of from 0.1 ml/min to 0.8 ml/min.

6-8. (canceled)

9. The system according to claim 1, wherein the first tube and second tube are configured to be movable relative to the rotatable collector along an axis that is substantially parallel to the longitudinal axis of the rotatable collector.

10. The system according to claim 1, further comprising an elongate support member having a longitudinal axis arranged to be substantially parallel to the longitudinal axis of the rotatable collector, wherein the elongate support member comprises a plurality of the first tube and second tube coupled thereto, and wherein the elongate support member is configured to be movable along its longitudinal axis relative to the rotatable collector.

11. The system according to claim 1, further comprising a guide member coupled to the first and second tubes, said guide member comprising a surface with one or more grooves formed thereon for guiding a flow direction of the first and second liquid compositions, and a groove tip disposed at one end of the one or more grooves for focusing the first and second liquid compositions prior to leaving the guide member.

12. A method of creating a fibre, the method comprising,
positioning a first tube in proximity with respect to a second tube;
dispensing a first liquid composition from the first tube having a first tube outlet at a first dispensing rate;
dispensing a second liquid composition from the second tube having a second tube outlet at a second dispensing rate;
forming an interfacial polyelectrolyte complex between the first liquid composition from the first tube outlet and the second liquid composition from the second tube outlet;
drawing a fibre from the interfacial polyelectrolyte complex; and
applying a drawing force by rotating the rotatable collector about its longitudinal axis that is aligned substantially parallel to a horizontal plane to draw and collect the fibre.

13. The method according to claim 12, wherein forming the interfacial polyelectrolyte complex and drawing the fibre from the interfacial polyelectrolyte complex comprise,
allowing the first liquid composition dispensed from the first tube outlet to flow into the second tube outlet via capillary action to form the interfacial polyelectrolyte complex with the second liquid composition within the second tube, ejecting the fibre from the interfacial polyelectrolyte complex through a dispensing force provided by the second dispensing rate in the second tube, and contacting the fibre on a target location on a surface of the rotatable collector;
and/or
allowing the first liquid composition dispensed from the first tube outlet and the second liquid composition dispensed from the second tube outlet to form a droplet, said droplet comprising the first and second liquid compositions separated by the interfacial polyelectrolyte complex within the droplet, allowing the droplet to travel and contact a target location on a surface of the rotatable collector, and drawing the fibre from the interfacial polyelectrolyte complex within the droplet that is in contact with the target location on the surface of the rotatable collector.

14. The method according to claim 13, wherein the fibre is allowed to move in a direction away from the outlets of the first and second tubes upon contacting the target location on the surface of the rotatable collector when the rotatable collector is in rotation.

15. The method according to claim 12, wherein rotating the rotatable collector comprises drawing the fibre from the interfacial polyelectrolyte complex with a drawing force that allows the fibre to be continuously increasing in length.

16. The method according to claim 12,
wherein the first liquid composition comprises a crosslinker and the second liquid composition comprises a polyion; or
wherein the first liquid composition comprises a first polyion and the second liquid composition comprises a second polyion, where the first polyion and the second polyion are oppositely charged.

17. The method according to claim 16,
wherein the first liquid composition comprising the crosslinker has a concentration falling in the range of from 0.5% (w/v) to 5% (w/v) of the first liquid composition, and the second liquid composition comprising the polyion has a concentration falling in the range of from 0.5% (w/v) to 1.2% (w/v) of the second liquid composition; or
wherein the first liquid composition comprising the first polyion has a concentration falling in the range of from 0.5% (w/v) to 2.5% (w/v) of the first liquid composition, and the second liquid composition comprising the second polyion has a concentration falling in the range of from 0.5% (w/v) to 1.2% (w/v) of the second liquid composition.

18. The method according to claim 16, wherein the first and/or second liquid compositions further comprise one or more of the following components:
5% (w/v) to 20% (w/v) of at least one protein isolate;
5% (w/v) to 20% (w/v) of at least one flour;
5% (v/v) to 20% (v/v) of at least one oil; and
0.5% (w/v) to 2.5% (w/v) of at least one gum.

19. The method according to claim 16, wherein the second liquid composition comprising the polyion or second polyion has a viscosity of from 5,000 to 50,000 cPs.

20. The method according to claim 12, wherein the rotatable collector is rotated about the longitudinal axis at a rotational speed falling in the range of from 1.5 RPM to 8 RPM;
optionally wherein the first and second dispensing rates fall in the range of from 0.1 ml/min to 0.8 ml/min; and
optionally wherein the fibre has an average diameter falling in the range of from 0.05 mm to 0.50 mm.

21-22. (canceled)

23. The method according to claim 12, further comprising maintaining the first and second tubes in a fixed position relative to the longitudinal axis of the rotatable collector, such that newly drawn portions of the fibre are overlaid on top of previously drawn portions of the fibre collected on the rotatable collector.

24. The method according to claim 12, further comprising moving the first tube and second tube relative to the rotatable collector along an axis that is substantially parallel to the longitudinal axis of the rotatable collector, such that newly drawn portions of the fibre are laid adjacent to previously drawn portions of the fibre collected on the rotatable collector.

25. The method according to claim 12, further comprising
dispensing the first and second liquid compositions from a plurality of the first tube and second tube, wherein the plurality of the first tube and second tube are coupled to an elongate support member having a longitudinal axis arranged to be substantially parallel to the longitudinal axis of the rotatable collector; and
moving the elongate support member along its longitudinal axis relative to the rotatable collector.
